(19) United States
(12) Patent Application Publication
(10) Pub. No.: US 2024/0201377 A1
(43) Pub. Date: Jun. 20, 2024

(54) COLLECTION AND USE OF ENHANCED LIDAR DATA

(71) Applicant: VELODYNE LIDAR USA, INC., San Jose, CA (US)

(72) Inventors: Stephen S. Nestinger, Fremont, CA (US); Mathew Noel Rekow, Santa Cruz, CA (US)

(21) Appl. No.: 18/082,923

(22) Filed: Dec. 16, 2022

(51) Int. Cl. G01S 17/89; G06V 10/25; G06V 10/764; G06V 20/56

(52) U.S. Cl. CPC G01S 17/89; G06V 10/25; G06V 10/764; G06V 20/56

(57) ABSTRACT

Methods and systems for collecting and using enhanced lidar point cloud data are provided. One example method includes using a lidar device to collect point cloud data for a surrounding environment. The method further includes determining that enhanced point cloud data should be obtained for a region of interest (ROI) in the environment. The method further includes, in response to the determination, collecting enhanced point cloud data for the object by at least one of: increasing a density of point cloud measurements within a region of interest (ROI) corresponding to the object, or moving a field of view (FOV) for the lidar device according to the ROI.

### FIELD OF TECHNOLOGY

The present disclosure relates generally to light detection and ranging (“lidar”) technology and, more specifically, to devices, systems, and methods for collecting and using enhanced lidar point cloud data.

### BACKGROUND

Lidar systems measure the attributes of their surrounding environments (e.g., shape of a target, contour of a target, distance to a target, etc.) by illuminating the environment with light (e.g., laser light) and measuring the reflected light with sensors. Differences in laser return times and/or wavelengths can be used to obtain a digital, three-dimensional (“3D”) point cloud representation of a surrounding environment, and the point cloud representation can be analyzed to detect, identify, and/or classify objects within the environment, such as background objects (e.g., buildings) and foreground objects (e.g., pedestrians, vehicles, etc.). Lidar technology may be used in various applications including autonomous vehicles, advanced driver assistance systems, mapping, security, surveying, robotics, geology and soil science, agriculture, unmanned aerial vehicles, airborne obstacle detection (e.g., obstacle detection systems for aircraft), etc. Depending on the application and associated field of view, multiple optical transmitters and/or optical receivers may be used to produce images in a desired resolution. A lidar system with greater numbers of transmitters and/or receivers can generally generate larger numbers of pixels.

In a multi-channel lidar device, optical transmitters can be paired with optical receivers to form multiple “channels.” In operation, each channel's transmitter can emit an optical signal (e.g., laser light) into the device's environment, and the channel's receiver can detect the portion of the signal that is reflected back to the channel's receiver by the surrounding environment. In this way, each channel can provide “point” measurements of the environment, which can be aggregated with the point measurements provided by the other channel(s) to form a “point cloud” of measurements of the environment.

The measurements collected by a lidar channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the wavelength (or frequency) of the return signal(s) reflected by the surface.

In some cases, lidar measurements may be used to determine the reflectance of the surface that reflects an optical signal. The reflectance of a surface may be determined based on the intensity of the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter of this disclosure relates to devices, systems, and methods for collecting and using enhanced lidar point cloud data. In one aspect, according to some embodiments, a lidar method is disclosed. The lidar method includes using a lidar device on a vehicle to collect point cloud data for a surrounding environment. The method further includes determining that enhanced point cloud data should be obtained for a region of interest (ROI) in the environment. In response to the determination, the method includes collecting enhanced point cloud data for the object by at least one of: increasing a density of point cloud measurements within a region of interest (ROI) corresponding to the object, or moving a field of view (FOV) for the lidar device according to the ROI.

In another aspect, according to some embodiments, a lidar system is disclosed. The lidar system includes a lidar device configured to collect point cloud data for a surrounding environment. The lidar system further includes at least one computer processor programmed to perform operations including: determining that enhanced point cloud data should be obtained for a region of interest (ROI) in the environment; and in response to the determination, instructing the lidar device to collect the enhanced point cloud data by at least one of: increasing a density of point cloud measurements within the ROI; or moving a field of view (FOV) for the lidar device according to the ROI.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is an illustration of an exemplary lidar system, in accordance with some embodiments.

FIG. 2A is an illustration of the operation of a lidar system, in accordance with some embodiments.

FIG. 2B is an illustration of optical components of a channel of a lidar system with a movable mirror, in accordance with some embodiments.

FIG. 2C is an illustration of an example of a 3D lidar system, in accordance with some embodiments.

FIG. 2D is a block diagram of a transmitter-receiver optical sub-assembly (TROSA), according to some embodiments.

FIG. 3 is a schematic top view of a field of view (FOV) for a lidar device on a vehicle, in accordance with some embodiments.

FIG. 4 is a schematic top view of an FOV that is narrower than the FOV in FIG. 3, in accordance with some embodiments.

FIG. 5 is a schematic representation of a point cloud from the perspective of a lidar device, in accordance with some embodiments.

FIG. 6 is a schematic representation of a point cloud having a narrower FOV, compared to the point cloud in FIG. 5, in accordance with some embodiments.

FIG. 7 is a flowchart of an example method of implementing a zoom mode, in accordance with some embodiments.

FIG. 8 is a schematic top view of an object within an FOV of a lidar device, in accordance with some embodiments.

FIG. 9 is a schematic side view of an object within an FOV of a lidar device, in accordance with some embodiments.

FIG. 10 is a schematic representation of a point cloud having a higher density in a region of interest, in accordance with some embodiments.

FIG. 11 is a schematic side view of an object within an FOV of a lidar device, in accordance with some embodiments.

FIG. 12 is a schematic side view of an example in which the FOV of a lidar device has been tilted upward, in accordance with some embodiments.

FIG. 13 is a schematic side view of an example in which the FOV of a lidar device has been tilted downward, in accordance with some embodiments.

FIG. 14 is a flowchart of an example method of implementing a burst mode and/or an FOV shift mode, in accordance with some embodiments.

FIG. 15 is a schematic illustration of an example continuous wave (CW) coherent lidar system, in accordance with some embodiments.

FIG. 16 is a schematic illustration of an example frequency modulated continuous wave (FMCW) coherent lidar system, in accordance with some embodiments.

FIG. 17A is a plot of a frequency chirp as a function of time in a transmitted laser signal and reflected signal, in accordance with some embodiments.

FIG. 17B is a plot illustrating a beat frequency of a mixed signal, in accordance with some embodiments.

FIG. 17C is a diagram of a vehicle including a plurality of sensors, in accordance with some embodiments.

FIG. 17D is a block diagram of a silicon photonic integrated circuit (PIC), in accordance with some embodiments.

FIG. 18 is a schematic block diagram of an example computer system, in accordance with some embodiments.

FIG. 19 is a schematic block diagram of a computing device/information handling system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

In various examples, the subject matter of this disclosure relates to the collection and use of enhanced lidar data. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

Three of the most significant technical challenges faced by the lidar industry are (1) reducing the manufacturing cost for lidar devices while maintaining existing performance levels, (2) improving the reliability of lidar devices under automotive operating conditions (e.g., weather, temperature, and mechanical vibration), and (3) increasing the range of lidar devices. One approach to reducing manufacturing costs is to reduce the amount of hardware (e.g., channels, transmitters, emitters, receivers, detectors, etc.) in the lidar device while increasing the utilization of the remaining hardware to maintain performance levels. One approach to improving device reliability is to develop lidar devices that use fewer moving mechanical parts (e.g., by eliminating or simplifying mechanical beam scanners). One approach to extending range is to develop lidar devices that use solid-state lasers.

### Motivation for and Benefits of Some Embodiments

In various instances, point cloud data obtained from a lidar device can be insufficient for purposes of detecting and identifying objects in a surrounding environment. For example, the point cloud may enable a lidar device (or an associated processor) to determine that an object is present in the surrounding environment, but the lidar device may be unable to classify the object (e.g., as a person or vehicle) and/or characterize the object (e.g., determine a location, an orientation, and/or a velocity of the object). When the lidar device is used in a vehicle control system, the insufficient point cloud data can prevent the vehicle control system from being able to make proper vehicle control decisions with respect to the object.

To address these shortcomings, in various examples, the subject matter of this disclosure relates to devices, systems, and methods for obtaining enhanced lidar point cloud data. The enhanced lidar point cloud data can be or include, for example, point cloud data that has a higher density (e.g., more points per area) and/or provides better coverage for objects or regions of interest (ROIs). In some instances, for example, the enhanced point cloud data can be obtained by decreasing a field of view (FOV) for the lidar device but maintaining a number of points in the point cloud for the FOV. This can result in a point cloud having datapoints that are closer together (higher density). Additionally or alternatively, the enhanced point cloud data can be obtained by increasing a rate at which optical signals or laser beams are emitted from the lidar device within an ROI for the FOV. For example, when an unidentified object is detected within the FOV, the lidar device can emit optical signals at a higher rate within an ROI for the object, to achieve a higher point cloud density in the ROI, compared to regions outside the ROI. Additionally or alternatively, the enhanced point cloud data can be obtained by translating the FOV of the lidar device toward an object. For example, when an unidentified object is detected at an edge of the FOV, the entire FOV and associated optical signal locations can be translated (e.g., up or down) to encompass or fully encapsulate the object or portions thereof. Advantageously, the enhanced point cloud data can be used to improve object detection, object characterization, and/or object classification, as described herein.

In various examples, a “field of view” or “FOV” for a lidar device can be or include an area of an environment that can be viewed, scanned, or imaged by the lidar device. A cross-section of the FOV (e.g., at a given distance from the lidar device) can be rectangular, square, or circular, or can have any other shape. The cross-section of the FOV can be defined by an azimuth angle and an elevation angle and/or by a height and a width.

In various examples, a “region of interest” or “ROI” for a lidar device can be or include a portion of the FOV that has been selected for a particular purpose, such as, for example, identifying, classifying, or characterizing an object or event. For example, the ROI can include, encompass, or correspond to an object or event for which point cloud data will be obtained and analyzed. The ROI in the FOV can be rectangular, square, or circular, or can have any other shape (e.g., corresponding to a shape of an object).

### Some Examples of Lidar Systems

A lidar system may be used to measure the shape and contour of the environment surrounding the system. Lidar systems may be applied to numerous applications including autonomous navigation and aerial mapping of surfaces. In general, a lidar system emits light that is subsequently reflected by objects within the environment in which the system operates. The light may be emitted by a laser (e.g., a rapidly firing laser). Laser light travels through a medium and reflects off points of surfaces in the environment (e.g., surfaces of buildings, tree branches, vehicles, etc.). The reflected (and/or scattered) light energy returns to a lidar detector where it may be sensed and used to perceive the environment.

The science of lidar systems is based on the physics of light and optics. Any suitable measurement techniques may be used to determine the attributes of objects in a lidar system's environment. In some examples, the lidar system is configured to emit light pulses (e.g., individual pulses or sequences of pulses). The time each pulse (or pulse sequence) travels from being emitted to being received (“time of flight” or “TOF”) may be measured to determine the distance between the lidar system and the object that reflects the pulse. Lidar systems that operate in this way may be referred to as “pulsed lidar,” “TOF lidar,” “direct TOF lidar,” or “pulsed TOF lidar.” In some other examples, the time of flight may be calculated indirectly (e.g., using amplitude-modulated continuous wave (AMCW) structured light). Lidar systems that operate in this way may be referred to as “indirect TOF lidar” or “iTOF lidar.” In still other examples, the lidar system can be configured to emit continuous wave (CW) light. The wavelength (or frequency) of the received, reflected light may be measured to determine the distance between the lidar system and the object that reflects the light. In some examples, lidar systems can measure the speed (or velocity) of objects. Lidar systems that operate in this way may be referred to as “coherent lidar,” “continuous wave lidar,” or “CW lidar.” In a CW lidar system, any suitable variant of CW lidar sensing may be used. For example, frequency modulated continuous wave (FMCW) lidar sensing may be used.

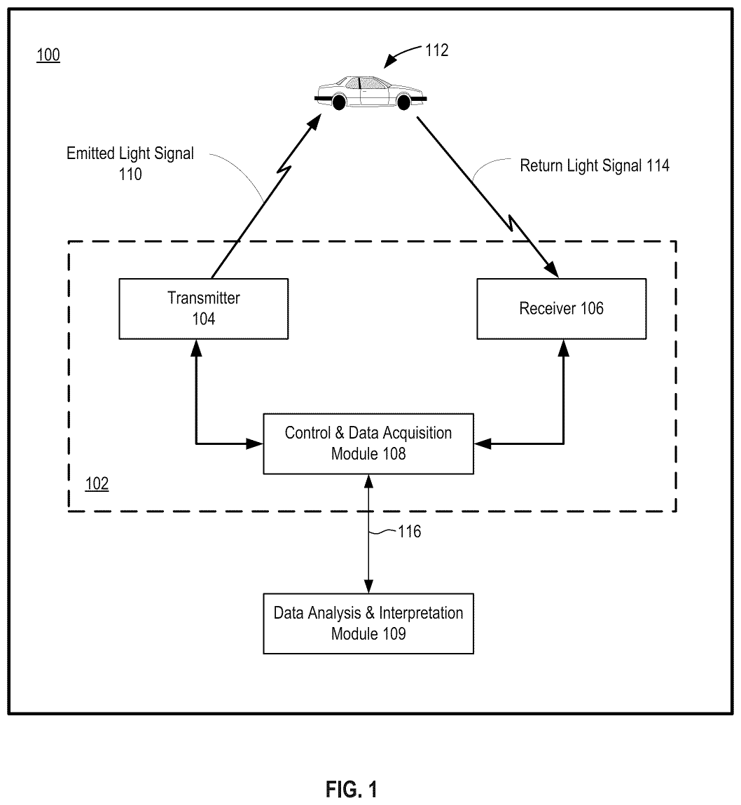

FIG. 1 depicts the operation of a lidar system 100, according to some embodiments. In the example of FIG. 1, the lidar system 100 includes a lidar device 102, which may include a transmitter 104 that generates and emits a light signal 110, a receiver 106 that detects and processes a return light signal 114, and a control & data acquisition module 108. The transmitter 104 may include a light source (e.g., “optical emitter” or “emitter”), electrical components operable to activate (e.g., drive) and deactivate the light source in response to electrical control signals, and optical components adapted to shape and redirect the light emitted by the light source. The receiver 106 may include a light detector (e.g., “optical detector,” “photodetector,” or “detector”) and optical components adapted to shape return light signals 114 and direct those signals to the detector. In some implementations, one or more optical components (e.g., lenses, mirrors, etc.) may be shared by the transmitter and the receiver.

The lidar device 102 may be referred to as a lidar transceiver or “channel.” In operation, the emitted light signal 110 propagates through a medium and reflects off an object(s) 112, whereby a return light signal 114 propagates through the medium and is received by receiver 106. In one example, each lidar channel may correspond to a physical mapping of a single emitter to a single detector (e.g., a one-to-one pairing of a particular emitter and a particular detector). In other examples, however, each lidar channel may correspond to a physical mapping of multiple emitters to a single detector or a physical mapping of a single emitter to multiple detectors (e.g., a “flash” configuration). In some examples, a lidar system 100 may have no fixed channels; rather, light emitted by one or more emitters may be detected by one or more detectors without any physical or persistent mapping of specific emitters to specific detectors.

Any suitable light source may be used including, without limitation, one or more gas lasers, chemical lasers, metal-vapor lasers, solid-state lasers (SSLs) (e.g., Q-switched SSLs, Q-switched solid-state bulk lasers, etc.), fiber lasers (e.g., Q-switched fiber lasers), liquid lasers (e.g., dye lasers), semiconductor lasers (e.g., laser diodes, edge emitting lasers (EELs), vertical-cavity surface emitting lasers (VCSELs), quantum cascade lasers, quantum dot lasers, quantum well lasers, hybrid silicon lasers, optically pumped semiconductor lasers, etc.), and/or any other device operable to emit light. For semiconductor lasers, any suitable gain medium may be used including, without limitation, gallium nitride (GaN), indium gallium nitride (InGaN), aluminum gallium indium phosphide (AlGaInP), aluminum gallium arsenide (AlGaAs), indium gallium arsenide phosphide (InGaAsP), lead salt, etc. For Q-switched lasers, any suitable type or variant of Q-switching can be used including, without limitation, active Q-switching, passive Q-switching, cavity dumping, regenerative Q-switching, etc. The light source may emit light having any suitable wavelength or wavelengths, including but not limited to wavelengths between 100 nm (or less) and 1 mm (or more). Semiconductor lasers operable to emit light having wavelengths of approximately 905 nm, 1300 nm, or 1550 nm are widely commercially available. In some examples, the light source may be operated as a pulsed laser, a continuous-wave (CW) laser, and/or a coherent laser. A light signal (e.g., “optical signal”) 110 emitted by a light source may consist of a single pulse, may include a sequence of two or more pulses, or may be a continuous wave.

A lidar system 100 may use any suitable illumination technique to illuminate the system's field of view (FOV). In some examples, the lidar system 100 may illuminate the entire FOV simultaneously. Such illumination techniques may be referred to herein as “flood illumination” or “flash illumination.” In some examples, the lidar system 100 may illuminate fixed, discrete spots throughout the FOV simultaneously. Such illumination techniques may be referred to herein as “fixed spot illumination.” In some examples, the lidar system 100 may illuminate a line within the FOV and use a scanner (e.g., a 1D scanner) to scan the line over the entire FOV. Such illumination techniques may be referred to herein as “scanned line illumination.” In some examples, the lidar system 100 may simultaneously illuminate one or more spots within the FOV and use a scanner (e.g., a 1D or 2D scanner) to scan the spots over the entire FOV. Such illumination techniques may be referred to herein as “scanned spot illumination.”

Any suitable optical detector may be used including, without limitation, one or more photodetectors, contact image sensors (CIS), solid-state photodetectors (e.g., photodiodes (PD), single-photon avalanche diode (SPADs), avalanche photodiodes (APDs), etc.), photomultipliers (e.g., silicon photomultipliers (SiPMs), and/or any other device operable to convert light (e.g., optical signals) into electrical signals. In some examples, CIS can be fabricated using a complementary metal-oxide semiconductor (CMOS) process. In some examples, solid-state photodetectors can be fabricated using semiconductor processes similar to CMOS. Such semiconductor processes may use silicon, germanium, indium gallium arsenide, lead (II) sulfide, mercury cadmium, telluride, MoS₂, graphene, and/or any other suitable material(s). In some examples, an array of integrated or discrete CIS or solid-state photodetectors can be used to simultaneously image (e.g., perform optical detection across) the lidar device's entire field of view or a portion thereof. In general, solid-state photodetectors may be configured to detect light having wavelengths between 190 nm (or lower) and 1.4 μm (or higher). PDs and APDs configured to detect light having wavelengths of approximately 905 nm, 1300 nm, or 1550 nm are widely commercially available.

The lidar system 100 may include any suitable combination of measurement technique(s), light source(s), illumination technique(s), and detector(s). Some combinations may be more accurate or more economical on certain conditions. For example, some combinations may be more economical for short-range sensing but incapable of provide accurate measurements at longer ranges. Some combinations may pose potential hazards to eye safety, while other combinations may reduce such hazards to negligible levels.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 or the receiver 106 determines (e.g., measures) particular characteristics of the return light signal 114 detected by the receiver 106. For example, the control & data acquisition module 108 or receiver 106 may measure the intensity of the return light signal 114 using any suitable technique.

Operational parameters of the transceiver 102 may include its horizontal field of view (“FOV”) and its vertical FOV. The FOV parameters effectively define the region of the environment that is visible to the specific lidar transceiver 102. More generally, the horizontal and vertical FOVs of a lidar system 100 may be defined by combining the fields of view of a plurality of lidar devices 102.

To obtain measurements of points in its environment and generate a point cloud based on those measurements, a lidar system 100 may scan its FOV. A lidar transceiver system 100 may include one or more beam-steering components (not shown) to redirect and shape the emitted light signals 110 and/or the return light signals 114. Any suitable beam-steering components may be used including, without limitation, mechanical beam steering components (e.g., rotating assemblies that physically rotate the transceiver(s) 102, rotating scan mirrors that deflect emitted light signals 110 and/or return light signals 114, etc.), optical beam steering components (e.g., lenses, lens arrays, microlenses, microlens arrays, beam splitters, etc.), microelectromechanical (MEMS) beam steering components (e.g., MEMS scan mirrors, etc.), solid-state beam steering components (e.g., optical phased arrays, optical frequency diversity arrays, etc.), etc.

In some implementations, the lidar system 100 may include or be communicatively coupled to a data analysis & interpretation module 109, which may receive outputs (e.g., via a connection 116) from the control & data acquisition module 108 and may perform data analysis on those outputs. By way of example and not limitation, connection 116 may be implemented using wired or wireless (e.g., non-contact communication) technique(s).

In some embodiments, the lidar system 100 may aggregate environmental data (e.g., range and/or reflectance data) including point cloud measurements. Within such point cloud data, objects and/or surfaces may be represented by one or more point measurements, such that the objects and/or surfaces may be identified (e.g., visually identified) using lidar-based object detection techniques. To identify such objects and/or surfaces, point cloud measurements may be supplied to “object detection” and/or “environmental perception” systems, which may be configured to analyze the point cloud measurements to identify one or more specified objects and/or surfaces, including vehicles, pedestrians, cyclists, road signs, lane markings, etc. The lidar system 100 may provide aggregated return signal data to an object detection and/or environmental perception system (e.g., included with and/or external to the lidar system 100). The object detection and/or environmental perception system may analyze the aggregated return signal data and may provide object detection data and/or information (e.g., indications of detected object(s) in the point cloud measurements) to the lidar system 100, such that the lidar system 100 may identify objects within aggregated point cloud measurements. Additionally or alternatively, in some instances, objects identified within point cloud data can be separated into background objects (e.g., buildings, hills, etc.) and foreground objects (e.g., pedestrians, vehicles, etc.). The foreground objects can be identified, for example, by taking multiple scans of an environment and identifying objects that moved from scan-to-scan. Objects that did not move from scan-to-scan may be identified as background objects.

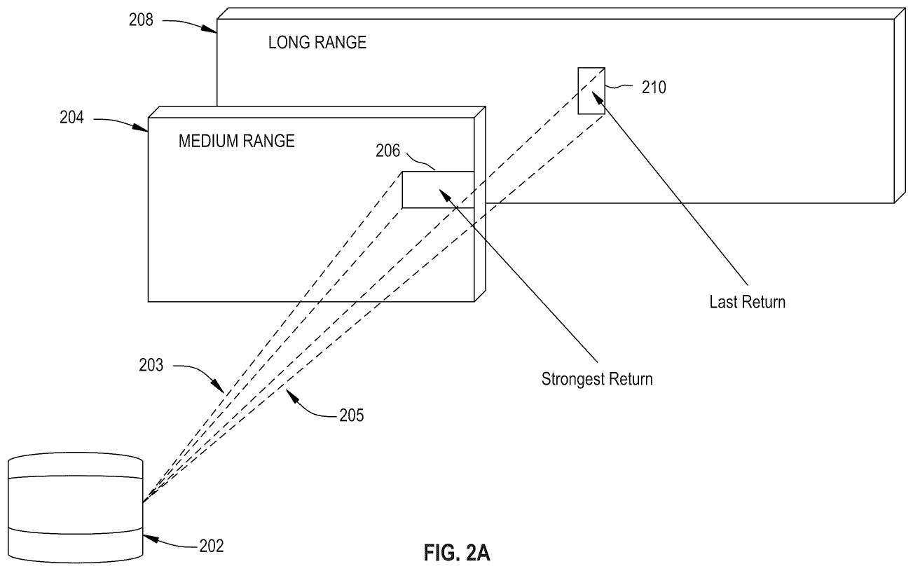

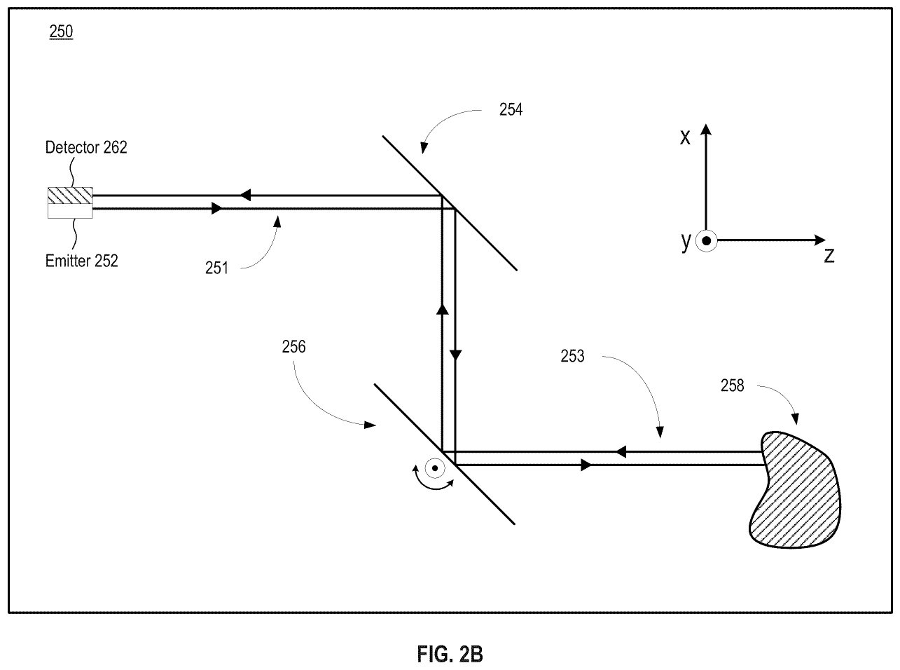

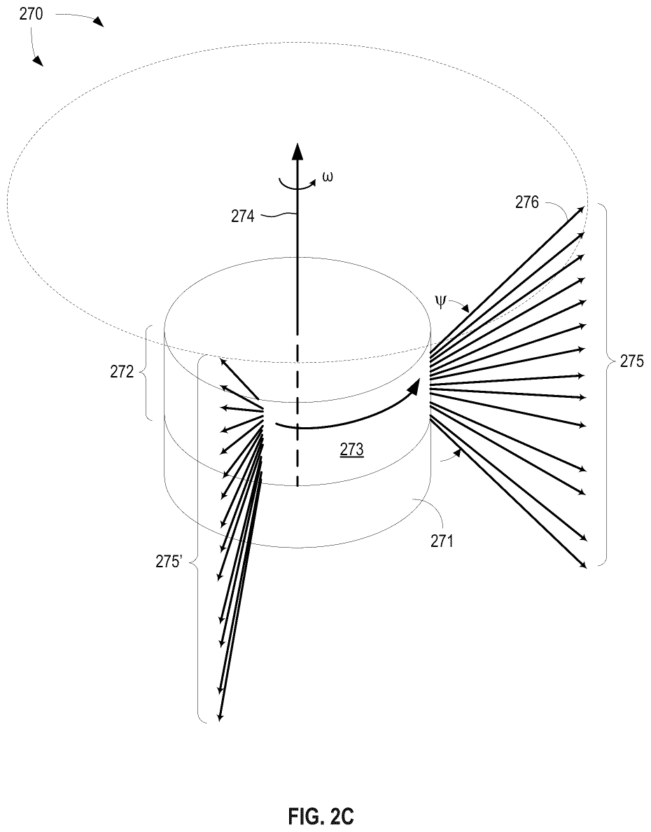

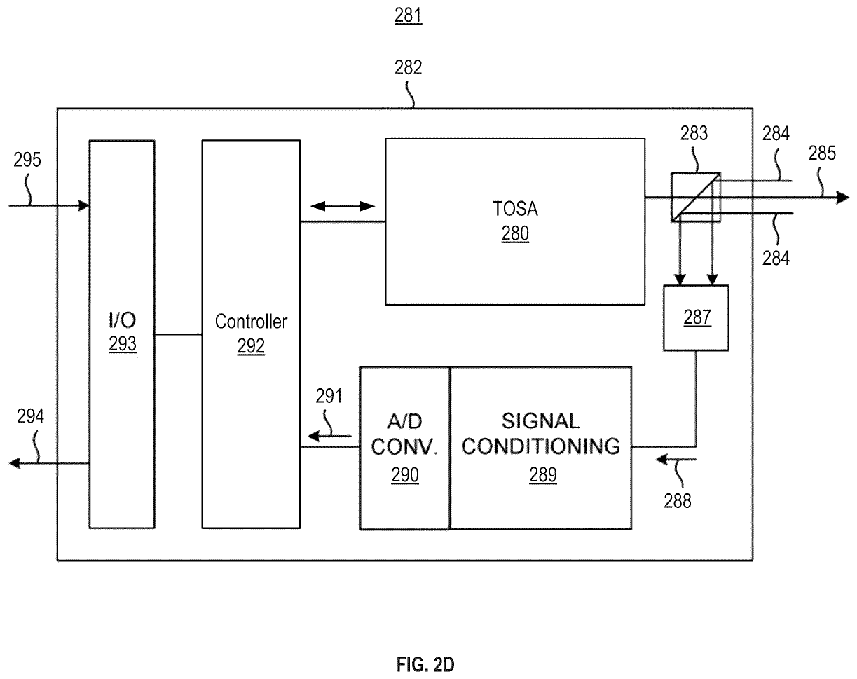

FIG. 2A illustrates the operation of a lidar system 202, in accordance with some embodiments. In the example of FIG. 2A, two return light signals 203 and 205 are shown. Because laser beams generally tend to diverge as they travel through a medium, a single laser emission may hit multiple objects at different ranges from the lidar system 202, producing multiple return signals 203, 205. The lidar system 202 may analyze multiple return signals 203, 205 and report one of the return signals (e.g., the strongest return signal, the last return signal, etc.) or more than one (e.g., all) of the return signals. In the example of FIG. 2A, lidar system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared to return signal 205. In both single- and multiple-return lidar systems, it is important that each return signal is accurately associated with the transmitted light signal so that one or more attributes of the object reflecting the light signal (e.g., range, velocity, reflectance, etc.) can be correctly estimated.

Some embodiments of a lidar system may capture distance data in a two-dimensional (“2D”) (e.g., within a single plane) point cloud manner. These lidar systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the lidar system to achieve 90-180-360 degrees of azimuth (horizontal) view while simplifying both the system design and manufacturability. Many applications require more data than just a 2D plane. The 2D point cloud may be expanded to form a 3D point cloud, in which multiple 2D point clouds are used, each corresponding to a different elevation (e.g., a different position and/or direction with respect to a vertical axis). Operational parameters of the receiver of a lidar system may include the horizontal FOV and the vertical FOV.

FIG. 2B depicts a lidar system 250 with a movable (e.g., rotating or oscillating) mirror, according to some embodiments. In the example of FIG. 2B, the lidar system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. In some embodiments, the movable mirror 256 is implemented with mechanical technology or with solid state technology (e.g., MEMS).

FIG. 2C depicts a 3D lidar system 270, according to some embodiments. In the example of FIG. 2C, the 3D lidar system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D lidar system 270 includes a lidar transceiver, such as transceiver 102 shown in FIG. 1, operable to emit laser beams 276 through the cylindrical shell element 273 of the upper housing 272. In the example of FIG. 2C, each individual arrow in the sets of arrows 275, 275′ directed outward from the 3D lidar system 270 represents a laser beam 276 emitted by the 3D lidar system. Each beam of light emitted from the system 270 (e.g., each laser beam 276) may diverge slightly, such that each beam of emitted light forms a cone of light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D lidar system 270. The direction of each emitted beam may be determined by the angular orientation ω of the transceiver's transmitter 104 with respect to the system's central axis 274 and by the angular orientation ψ of the transmitter's movable mirror (e.g., similar or identical to movable mirror 256 shown in FIG. 2B) with respect to the mirror's axis of oscillation (or rotation). For example, the direction of an emitted beam in a horizontal dimension may be determined by the transmitter's angular orientation ω, and the direction of the emitted beam in a vertical dimension may be determined by the angular orientation ψ of the transmitter's movable mirror. Alternatively, the direction of an emitted beam in a vertical dimension may be determined the transmitter's angular orientation ω, and the direction of the emitted beam in a horizontal dimension may be determined by the angular orientation ψ of the transmitter's movable mirror. (For purposes of illustration, the beams of light 275 are illustrated in one angular orientation relative to a non-rotating coordinate frame of the 3D lidar system 270 and the beams of light 275′ are illustrated in another angular orientation relative to the non-rotating coordinate frame.)

The 3D lidar system 270 may scan a particular point (e.g., pixel) in its field of view by adjusting the angular orientation ω of the transmitter and the angular orientation y of the transmitter's movable mirror to the desired scan point (ω, ψ) and emitting a laser beam from the transmitter 104. Accordingly, the 3D lidar system 270 may systematically scan its field of view by adjusting the angular orientation ω of the transmitter and the angular orientation y of the transmitter's movable mirror to a set of scan points (ωᵢ, ψⱼ) and emitting a laser beam from the transmitter 104 at each of the scan points.

Assuming that the optical component(s) (e.g., movable mirror 256) of a lidar transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location L0 on the detector. This time period is referred to herein as the “ranging period” or “listening period” of the scan point associated with the transmitted beam 110 and the return beam 114.

In many lidar systems, the optical component(s) of a lidar transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location Li of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location Li of the spot formed by the return beam and the nominal location L0 of the spot that would have been formed absent the intervening rotation of the optical component(s) during the ranging period is referred to herein as “walk-off.”

Referring to FIG. 2D, a block diagram of a transmitter-receiver optical subassembly (TROSA) 281 is shown, according to some embodiments. In some embodiments, the TROSA 281 may include a TOSA 280, an optical detector 287, a beam splitter 283, signal conditioning electronics 289, an analog to digital (A/D) converter 290, controller 292, and digital input/output (I/O) electronics 293. In some embodiments, the TROSA components illustrated in FIG. 2D are integrated onto a common substrate 282 (e.g., printed circuit board, ceramic substrate, etc.). In some embodiments, the TROSA components illustrated in FIG. 2D are individually mounted to a common substrate 282. In some embodiments, groups of these components are packaged together and the integrated package(s) is/are mounted to the common substrate.

The TOSA 280 may include one or more light sources and may operate the light source(s) safely within specified safety thresholds. A light source of the TOSA may emit an optical signal (e.g., laser beam) 285.

A return signal 284 may be detected by the TROSA 281 in response to the optical signal 285 illuminating a particular location. For example, the optical detector 287 may detect the return signal 284 and generate an electrical signal 288 based on the return signal 284. The controller 292 may initiate a measurement window (e.g., a period of time during which collected return signal data are associated with a particular emitted light signal 285) by enabling data acquisition by optical detector 287. Controller 292 may control the timing of the measurement window to correspond with the period of time when a return signal is expected in response to the emission of an optical signal 285. In some examples, the measurement window is enabled at the time when the optical signal 285 is emitted and is disabled after a time period corresponding to the time of flight of light over a distance that is substantially twice the range of the lidar device in which the TROSA 281 operates. In this manner, the measurement window is open to collect return light from objects adjacent to the lidar device (e.g., negligible time of flight), objects that are located at the maximum range of the lidar device, and objects in between. In this manner, other light that does not contribute to a useful return signal may be rejected.

In some embodiments, the signal analysis of the electrical signal 288 produced by the optical detector 287 is performed by the controller 292, entirely. In such embodiments, the signals 294 provided by the TROSA 281 may include an indication of the distances determined by controller 292. In some embodiments, the signals 294 include the digital signals 291 generated by the A/D converter 290. These raw measurement signals 291 may be processed further by one or more processors located on board the lidar device or external to the lidar device to arrive at a measurement of distance. In some embodiments, the controller 292 performs preliminary signal processing steps on the signals 291 and the signals 294 include processed data that are further processed by one or more processors located on board the lidar device or external to the lidar device to arrive at a measurement of distance.

In some embodiments a lidar device (e.g., a lidar device 100, 202, 250, or 270) includes multiple TROSAs 281. In some embodiments, a delay time is enforced between the firing of each TROSA and/or between the firing of different light sources within the same TROSA. In some examples, the delay time is greater than the time of flight of the light signal 285 to and from an object located at the maximum range of the lidar device, to reduce or avoid optical cross-talk among any of the TROSAs 281. In some other examples, an optical signal 285 is emitted from one TROSA 281 before a return signal corresponding to a light signal emitted from another TROSA 281 has had time to return to the lidar device. In these embodiments, there may be sufficient spatial separation between the areas of the surrounding environment interrogated by the light signals of these TROSAs to avoid optical cross-talk.

In some embodiments, digital I/O 293, A/D converter 290, and signal conditioning electronics 289 are integrated onto a single, silicon-based microelectronic chip. In another embodiment, these same elements are integrated into a single gallium-nitride or silicon based circuit that also includes components of the TOSA 280 (e.g., an illumination driver). In some embodiments, the A/D converter 290 and controller 292 are combined as a time-to-digital converter.

As depicted in FIG. 2D, return light 284 reflected from the surrounding environment is detected by optical detector 287. In some embodiments, optical detector 287 includes one or more avalanche photodiodes (APDs) and/or single-photon avalanche diodes (SPADs). Any suitable optical detector may be used. In some embodiments, optical detector 287 generates an output signal 288 that is amplified by signal conditioning electronics 289. In some embodiments, signal conditioning electronics 289 include an analog trans-impedance amplifier. However, in general, the amplification of output signal 288 may include multiple amplifier stages. In this sense, an analog transimpedance amplifier is provided by way of non-limiting example, as many other analog signal amplification schemes may be used.

In some embodiments, the amplified signal is communicated to A/D converter 290, and the digital signals generated by the A/D converter are communicated to controller 292. Controller 292 may generate an enable/disable signal to control the timing of data acquisition by ADC 290.

As depicted in FIG. 2D, the optical signal 285 emitted from the TROSA 281 and the return signal 284 directed toward the TROSA 281 share a common path within the lidar device. In the embodiment depicted in FIG. 2D, the return light 284 is separated from the emitted light 285 by a beam splitter 283. The beam splitter may direct the light 285 emitted by the TOSA 280 toward the lidar device's environment, and direct the return light 284 to the optical detector 287. Any suitable beam splitter may be used, including (without limitation) a polarizing beam splitter, nonpolarizing beam splitter, dielectric film, etc.). Some non-limiting examples of suitable beam splitters are described in International Patent Publication No. WO 2017/164989.

Improved Lidar Scan Resolution with Zoom Mode

FIG. 3 is a top, schematic view of a vehicle 302 (e.g., a car or bus) using a lidar device 304 to scan an environment 306 while driving down a road 308. The lidar device 304 can be mounted at any desired location on the vehicle 302 (e.g., on a roof, a hood, or a grill). The lidar device 304 can have a field of view (FOV) 310 corresponding to a portion of the environment 306. The FOV 310 can be defined by an azimuth angle θ₁, which in general can be from about 30° to about 180°. While FIG. 3 depicts a vehicle on a road, it is understood that the lidar device 304 can be mounted on or associated with any other type of vehicle or machine (e.g., a drone, a robot, a remote-controlled vehicle, an aircraft, a boat, a spacecraft, etc.) in any other type of environment (e.g., a building, a forest, a field, an airspace, outer space, etc.).

FIG. 3 depicts the azimuth angle θ₁ when the vehicle 302 is driving at a relatively slow velocity V₁ (e.g., 30 mph or 48 kph or less). The azimuth angle θ₁ at the slow velocity V₁ can be, for example, from about 120° to about 180°, or about 150°. In general, a wide azimuth angle can enable the lidar device 304 to scan areas that are located off to a side of the vehicle 302, such as, for example, a side of the road 308, a sidewalk, an adjacent road, or other areas outside a path of the vehicle 302. It can be important to scan such areas for pedestrians, animals, or other vehicles, particularly in city environments, residential areas, or other environments where vehicle speeds are limited.

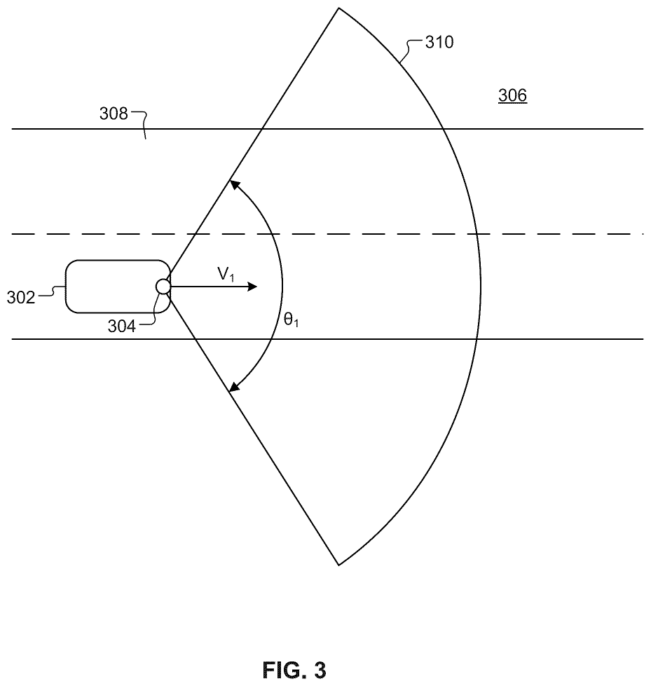

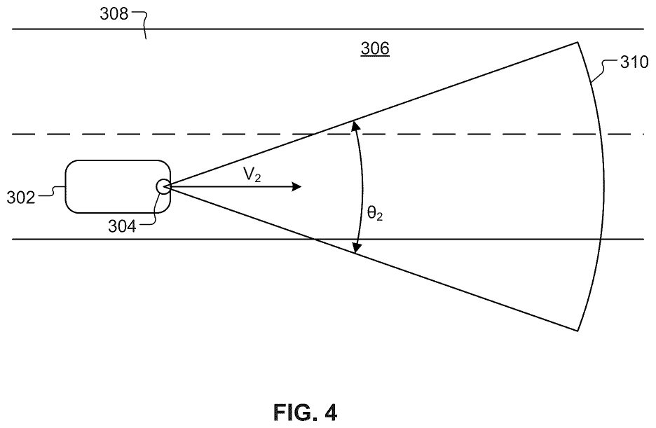

FIG. 4 is a top, schematic view of the vehicle 302 driving down the road 308 at a higher velocity V2 (e.g., greater than 60 mph). In this case, it can be less important to scan regions off to the sides of the vehicle 302 and more important to scan regions that are in front of the vehicle 302. For example, high speed travel on a highway generally does not require objects located to the side of the vehicle 302 to be detected for safe vehicle operation. Accordingly, in such instances, an azimuth angle θ₂ for the FOV 310 can be smaller at velocity V₂, compared to the azimuth angle θ₁ at velocity V₁ The azimuth angle θ₂ at velocity V2 can be, for example, from about 40° to about 100°. Table 1 illustrates example minimum, maximum, and typical FOV azimuth angles that can be used for various vehicle speeds.

TABLE 1
FOV azimuth angles for various vehicle speeds.

| | Minimum | Maximum | Typical |
|---|---|---|---|
| Vehicle Speed | Azimuth Angle | Azimuth Angle | Azimuth Angle |
| 0 to 30 mph | 90 | 150 | 120 |
| (0 to 48 kph) | | | |
| 30 to 60 mph | 60 | 120 | 90 |
| (48 to 97 kph) | | | |
| >60 mph | 30 | 90 | 60 |
| (>97 kph) | | | |

In various examples, the azimuth angle for the FOV 310 can be adjusted (e.g., automatically) according to vehicle speed. For example, the lidar device 304 can receive an indication of the vehicle speed from a speedometer or a vehicle control system on the vehicle 302, and the lidar 304 device or a processor associated with the lidar device 304 can adjust the azimuth angle accordingly. Such adjustments can be made using a reference table, such as Table 1, or using an equation that relates the azimuth angle to vehicle speed. In some examples, the azimuth angle for the FOV 310 can be adjusted when the vehicle speed changes (e.g., decrease the azimuth angle when speed increases) or when the vehicle speed reaches a threshold value (e.g., decrease the azimuth angle when the speed is greater than 60 mph or 97 kph).

In some instances, the azimuth angle can be adjusted according to other sensor data. For example, a global positioning system (GPS) device on the vehicle 302 can monitor a location of the vehicle 302 and send location information to the lidar device 304. When the location information indicates that the vehicle 302 has moved from a residential area to a highway, for example, the lidar device 304 (or associated processor) can decrease the azimuth angle based on the updated location of the vehicle 302. Likewise, when the GPS determines that the vehicle 302 has moved to a slower-speed environment, such as a city street, the azimuth angle can be increased. Such adjustments can be made with or without considering the vehicle's current speed. Alternatively or additionally, the GPS location information can include a posted speed limit for the vehicle's location, and the lidar device 304 can adjust the azimuth angle according to the speed limit (e.g., a lower azimuth angle in a high-speed area).

In the examples depicted in FIGS. 3 and 4, the FOV 310 can be centered over a path of the vehicle 302 or over a centerline of the vehicle 302. In alternative examples, the center of the FOV 310 can be shifted left or right according to a predicted path of the vehicle 302. For example, when a steering wheel for the vehicle 302 is turned to the left, the center of the FOV 310 can be shifted to the left. Likewise, when the steering wheel is turned to the right, the center of the FOV 310 can be shifted to the right. The lidar device 304 can position the center the FOV 310 over the predicted path of the vehicle 302. To shift the FOV 310 to the right or left, the lidar device can be mounted on rotatable platform (e.g., a turntable) that rotates the entire Lidar device (including the transmitters, window, etc.), as needed, to achieve a desired direction for the FOV 310. Alternatively or additionally, an angle of a rotatable mirror (e.g., mirror 256) can be adjusted to shift the FOV 310 to the right or left.

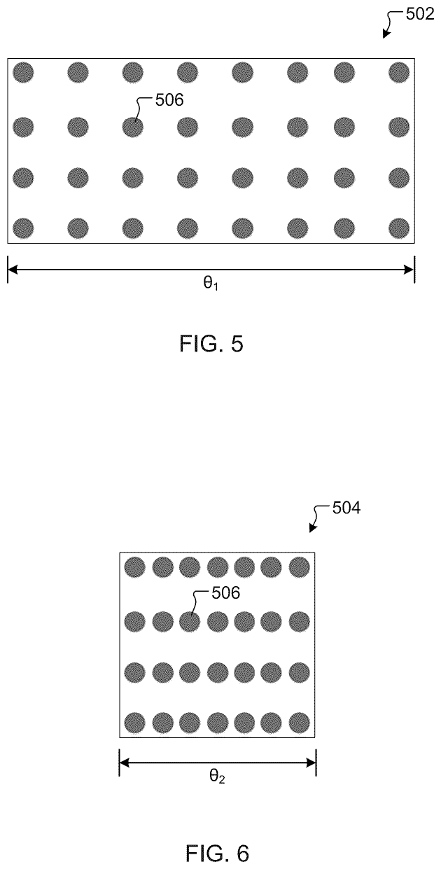

FIGS. 5 and 6 include schematic diagrams of example point clouds 502 and 504 obtained with azimuth angles θ₁ and θ₂, respectively. The point clouds 502 and 504 correspond to an FOV (e.g., the FOV 310) as seen from the perspective of a lidar device (e.g., the lidar device 304). For simplicity, data points 506 in the point clouds 502 and 504 are arranged in a grid having rows and columns, and each figure includes only a small subset of the data points 506 that would be present in an actual point cloud. In various examples, each column of data points 506 can be generated by oscillating (or rotating) a mirror (e.g., mirror 256) or one or more channels in the lidar device. As the mirror oscillates, transmitters (e.g., transmitter 104) in the channels can send optical signals into the environment and corresponding receivers (e.g., receiver 106) in the channels can receive reflections from the environment. The reflections can be processed and used to generate a column of point cloud data, as described herein. Each column of datapoints 506 can correspond to an angular position of the mirror or channels in the lidar device.

In the depicted examples, the smaller azimuth angle θ₂ for point cloud 504 can result in a smaller spacing between adjacent columns of data points 506, compared to the column spacing achieved with azimuth angle θ₁ for point cloud 502. In various implementations, the two point clouds 502 and 504 can be generated by emitting signals at the same rate or frequency (e.g., in Hz) and rotating or oscillating the mirror faster for the larger azimuth angle θ₁ and slower for the smaller azimuth angle θ₁. Alternatively, the two point clouds 502 and 504 can be generated by rotating or oscillating the mirror at the same rate (e.g., in RPM) and emitting signals at a slower rate for the larger azimuth angle θ₁ and at a faster rate for the smaller azimuth angle θ₂. Advantageously, the smaller column spacing in FIG. 6 provides a higher-resolution point cloud for the smaller azimuth angle θ₂. This can allow the lidar device to achieve higher resolution scans in front of a vehicle when the vehicle is traveling at high speed and a smaller azimuth angle is used for the FOV, as described for FIGS. 3 and 4, above. This concept of reducing the azimuth angle to increase scan resolution can be referred to as “zoom mode.”

While FIG. 4 depicts an example in which the azimuth angle was decreased (compared to FIG. 3) to achieve a greater horizontal resolution (e.g., a higher density of point cloud datapoints in a horizontal direction), it is understood that an elevation angle or height for the FOV can be decreased to achieve a greater vertical resolution (e.g., a higher density of point cloud datapoints in a vertical direction). The azimuth angle and the elevation angle can be adjusted together or separately. The elevation angle for the FOV can be changed, for example, by adjusting vertical orientations of the transmitters (and associated optical signals) in the lidar device and/or by biasing the deflection of a mirror (e.g., mirror 256) in the lidar device.

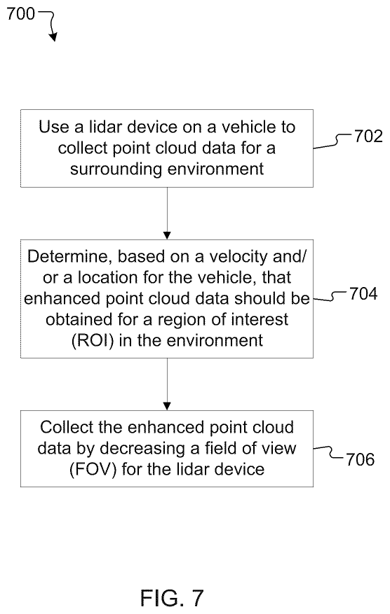

FIG. 7 is a flowchart of an example method 700 of implementing zoom mode. A lidar device on a vehicle is used (step 702) to collect point cloud data for a surrounding environment. It is determined (step 704), based on at least one of a velocity or a location for the vehicle, that enhanced point cloud data should be obtained for a region of interest (ROI) in the environment. In response to the determination, the enhanced point cloud data is collected (step 706) by decreasing a field of view (FOV) for the lidar device.

In various examples, zoom mode can involve compressing the FOV in a horizontal direction and/or in a vertical direction and can be used to improve object detection and identification. For example, it can be desirable for last-mile delivery robots, pallet robots, or similar devices to reduce the vertical FOV of the lidar sensor to achieve higher resolution. The shorter FOV can be shifted down or up, as desired, to place objects of interest (e.g., steps, ledges, obstacles, etc.) within the FOV.

Improved Object Detection with Burst Mode

In certain examples, the lidar device 304 can be used to classify or characterize objects that appear in the FOV. For example, to “classify” an object, the lidar device 304 or an associated processor can identify the object as belonging to one or more categories, such as, for example, person, car, truck, motorcycle, bicycle, animal, plant, building, road sign, fire hydrant, telephone pole, or other class of objects. Likewise, to “characterize” the object, the lidar device 304 or the associated processor can determine one or more features for the object, such as, for example, a location, a speed, a heading, a velocity, an acceleration, an orientation, a shape, a size, a boundary, or any combination thereof.

To classify or characterize the object, the lidar device 304 or the associated processor can utilize one or more predictive models, such as machine learning models. The models can receive point cloud data as input and provide an object classification or characterization as output. For example, a machine learning model can be or include a classifier or a regression model that is trained to classify or characterize objects. The training can involve, for example, providing the machine learning model with point cloud training data covering a wide variety of objects at various orientations and distances in the point clouds (e.g., with respect to a lidar device). The model can be trained or adjusted using the training data until a desired prediction accuracy is achieved. Examples of predictive models can include one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models.

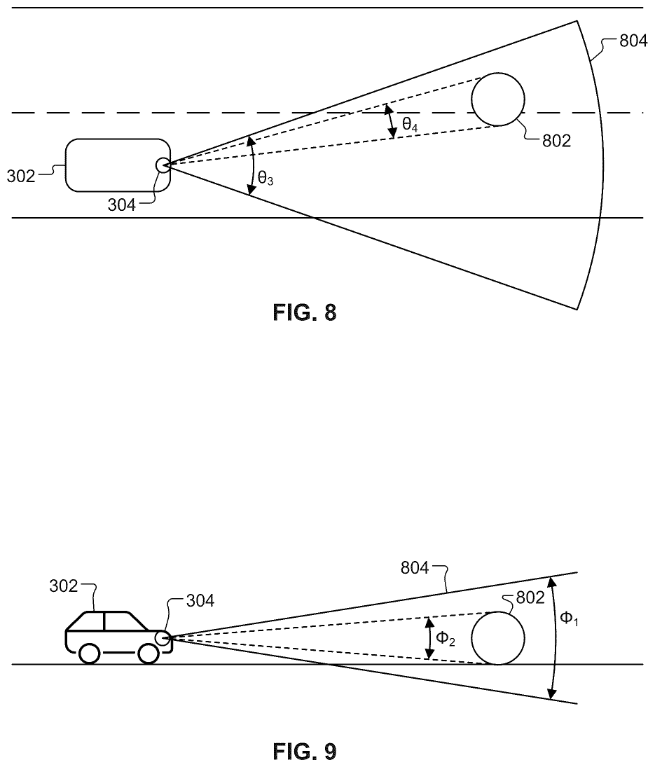

Referring to FIGS. 8 and 9, in various examples, an object 802 can appear within an FOV 804 of the lidar device 304. The lidar device 304 (or an associated processor) may detect a presence of the object 802 but may have insufficient point cloud data or resolution to be able to characterize or classify the object 802 (e.g., above a threshold level of confidence). For example, the lidar device 304 may be able to determine a general location for the object 802 but may be unable to determine if the object 802 is a person, a vehicle, an animal, a plant, a building, or other type of object (e.g., the object 802 may be unidentified). Additionally or alternatively, the lidar device 304 may have insufficient point cloud data or resolution to be able to determine a current position of the object 802, a current velocity of the object 802, a direction in which the object 802 is heading (e.g., with respect to the lidar device), and/or one or more boundaries or edges for the object 802. Due to the insufficient object characterization or classification, a vehicle control system in communication with the lidar device may be unable to determine how to control the vehicle 302 with respect to the object 802. For example, the vehicle control system may be unable to determine if corrective action needs to be taken to avoid contact between the vehicle 302 and the object 802. Accordingly, in such circumstances, the lidar device 304 can obtain enhanced point cloud data, which can be used to further characterize or classify the object 802.

In various examples, the enhanced point cloud data can be achieved by obtaining additional point cloud datapoints for the object 802. This can involve, for example, determining a general location or ROI for the object 802 and increasing a rate (e.g., in Hz) at which optical signals are sent from the lidar device 304 toward the general location. For example, when a transmitter (or multiple transmitters) in the lidar device 304 is sending optical signals towards the general location of the object 802, the rate at which the optical signals are sent from the transmitter (or multiple transmitters) can be increased (e.g., by a factor of 2, 3, 4, or more). Optical signals can be sent at a lower or nominal rate when the transmitter is sending optical signals to areas outside of the general location of the object 802. This process of sending optical signals at a higher rate toward the object 802 can be referred to herein as “burst mode.” FIG. 8 indicates that the FOV 804 has an azimuth angle θ₃ (e.g., defining an FOV width in a horizontal direction) and the object 802 corresponds to an azimuth angle θ₄, which occupies a portion of the FOV 804. FIG. 9 indicates that the FOV 804 has an elevation angle ϕ₁ (e.g., defining an FOV height in a vertical direction) and the object 802 corresponds to an elevation angle ϕ₂, which occupies a portion of the FOV 804. Burst mode can be achieved by sending optical signals at a higher rate within the azimuth angle θ₄ and/or the elevation angle ϕ₂, compared to the rate at which optical signals are sent to other regions of the FOV 804.

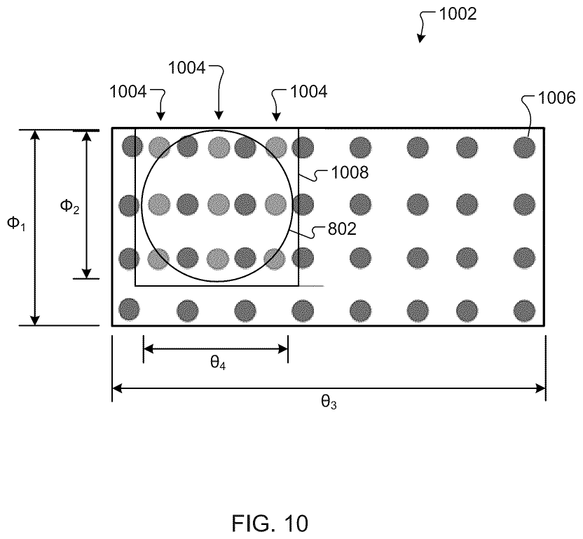

FIG. 10 includes a schematic diagram of an example point cloud 1002 generated using burst mode. In the depicted example, the point cloud 1002 includes additional columns 1004 of point cloud datapoints 1006 within an ROI 1008 associated with the object 802 (e.g., within the azimuth angle θ₄ and/or the elevation angle ϕ₂). The additional columns 1004 in this example can be obtained by doubling the rate at which optical signals are sent from the lidar device toward the object 802 or the ROI 1008. Other regions of the point cloud 1002 (e.g., outside of the azimuth angle θ₄ and/or the elevation angle ϕ₂) can receive optical signals at a lower rate (e.g., a standard, regular, or nominal rate). For example, the point cloud 1002 can be generated by rotating or oscillating a mirror (e.g., mirror 256) in the lidar device at a constant rate and emitting optical signals from transmitters at a higher rate when the optical signals are aimed towards the object 802 or the ROI 1008. Advantageously, burst mode can allow higher resolution point cloud data to be obtained for the object 802. This can allow the lidar device and/or an associated processor to better characterize or classify the object 802. A more accurate object characterization or classification can enable a vehicle control system to make better decisions when controlling a vehicle (e.g., vehicle 302) with respect to the object 802.

In certain examples, the rate at which optical signals are emitted by the lidar device can depend on how far away the object 802 is from the lidar device. For example, when a transmitter emits an optical signal, it is generally desirable to wait until a reflection of the optical signal is received before the transmitter emits another optical signal. The time between emitting the optical signal and receiving the reflection can be referred to as the time of flight (TOF). Objects that are closer to the lidar device can be associated with a shorter TOF, and objects that are further from the lidar device can be associated with a longer TOF. Accordingly, when the object 802 is close to the lidar device, a more rapid succession of optical signals can be emitted toward the object 802. In some examples, a rate at which optical signals are emitted can range from about 30 kHz to about 500 kHz, depending on a mode of operation of the lidar device and/or on how far away an object is from the lidar device.

In various examples, a listening window for the lidar device can be a time period after an optical signal is emitted and within which the lidar device listens or waits for a reflection of the optical signal. Use of burst mode can increase a horizontal resolution (e.g., a higher density of point cloud datapoints along a horizontal direction) by reducing the listening window, which allows for an increased firing rate of the emitter. A drawback of reducing the listening window, however, can be a reduction in detection range. Reducing the listening window by half can reduce the detection range by half but can double the emitter firing rate.

Improved Object Detection with FOV Shift

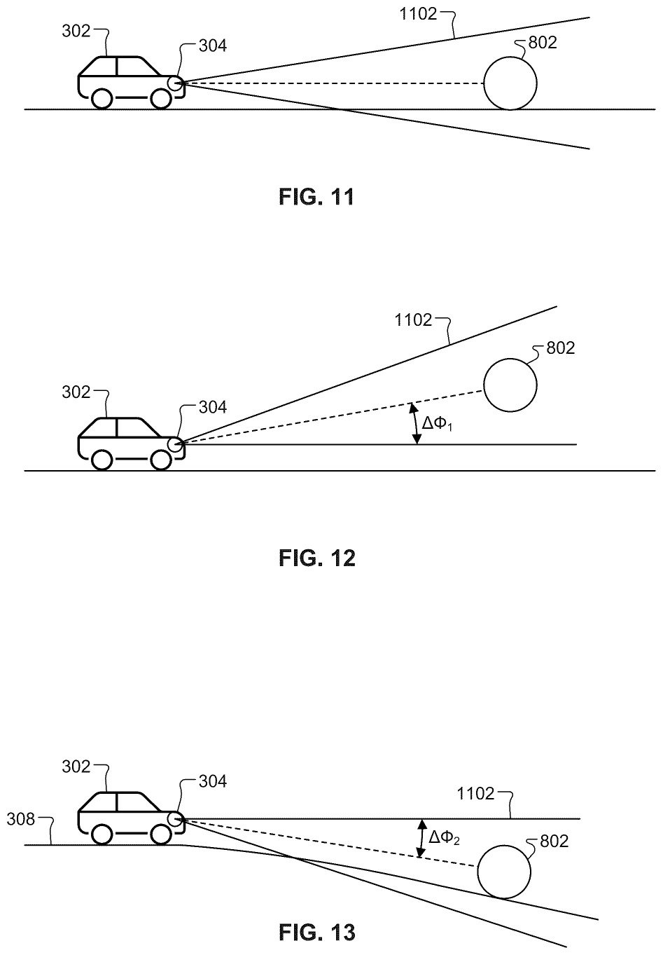

In certain implementations, enhanced point cloud data can be obtained by shifting or translating an FOV for a lidar device. For example, when the presence of the object 802 is detected by the lidar device, the FOV can be translated toward the object 802 (e.g., up, down, right, or left), in an effort to obtain enhanced point cloud data for characterizing or classifying the object 802. FIG. 11 depicts an example when the object 802 is in front of the vehicle 302 and falls within an FOV 1102 for the lidar device 304. In this case, there may be no need to translate the FOV 1102 up or down to fully encompass the object 802 within the FOV 1102. FIG. 12 depicts an example when the object 802 (e.g., a traffic light) is elevated above the vehicle 302. In such instances, enhanced point cloud data for the object 802 can be obtained by translating the FOV 1102 upward, by an elevation angle change Δϕ₁, until the object 802 is encompassed within the FOV 1102. Likewise, FIG. 13 depicts an example when the object 802 is at an elevation lower than the vehicle 302 (e.g., because of a drop in the road 308). In such instances, enhanced point cloud data for the object 802 can be obtained by translating the FOV 1102 downward, by an elevation angle change Δϕ₂, until the object 802 is encompassed within the FOV 1102. The elevation angle changes Δϕ₁ and Δϕ₂ can be, for example, from about 1° degree to about 90°, from about 1° to about 45°, from about 1° to about 30°, or from about 1° to about 15°. Such angle changes can be implemented by tilting a mirror (e.g., mirror 256) in the lidar device about a rotational axis for the mirror (e.g., using a servo drive). Additionally or alternatively, the angle changes can be implemented by adjusting an angle of one or more transmitters within the lidar device and/or by tilting the lidar device itself. The process of shifting or translating the FOV 1102 in this manner can be referred to as “FOV shift mode” or “vertical control mode.”

In alternative examples, the center of the FOV 1102 can be shifted left or right according to the location of the object 802. For example, when the object 802 is detected on a far left-hand edge of the FOV 1102, the center of the FOV 1102 can be shifted to the left. Likewise, when the object 802 is detected on a far right-hand edge of the FOV 1102, the center of the FOV 1102 can be shifted to the right. To shift the FOV 1102 to the right or left, the lidar device can be mounted on rotatable platform (e.g., a turntable) that rotates the entire lidar device (including the transmitters, window, etc.), as needed, to achieve a desired direction for the FOV 1102. Alternatively or additionally, an angle of a rotatable mirror (e.g., mirror 256) can be adjusted to shift the FOV 1102 to the right or left. In general, the FOV 1102 can be moved in any direction toward the object 802 (e.g., up, down, right, left, or any combination thereof), in an effort to obtain enhanced point cloud data for the object 802. The enhanced point cloud data can improve an ability of the lidar device to characterize or classify the object 802, which can improve the ability of the vehicle control system to control the vehicle 302, as described herein.

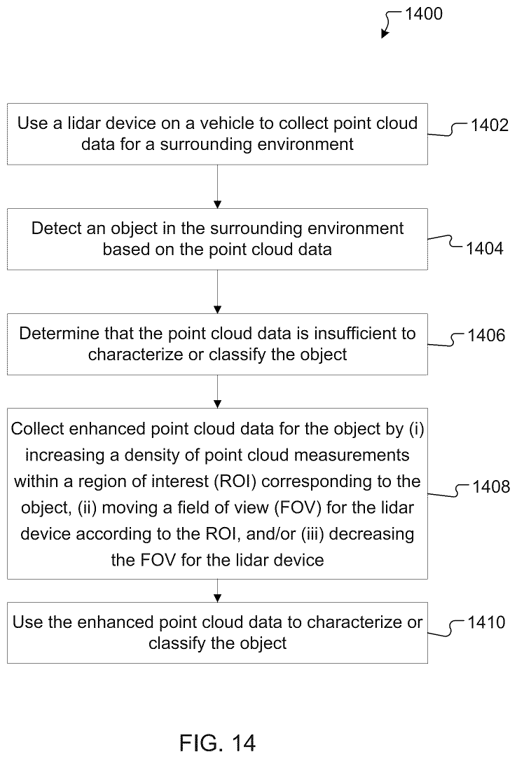

FIG. 14 is a flowchart of an example method 1400 of implementing burst mode and/or FOV shift mode. A lidar device is used (step 1402) to collect point cloud data for a surrounding environment. An object in the surrounding environment is detected (step 1404) based on the point cloud data. It is determined (step 1406) that the point cloud data is insufficient to characterize or classify the object. In response to the determination, enhanced point cloud data is collected (step 1408) for the object by (i) increasing a density of point cloud measurements within a region of interest (ROI) corresponding to the object, (ii) moving a field of view (FOV) for the lidar device according to the ROI, and/or (iii) decreasing the FOV for the lidar device. The enhanced point cloud data is used (step 1410) to characterize or classify the object.

In various implementations, a lidar device can be configured to select burst mode, zoom mode, and/or FOV shift mode, according to one or more selection criteria. For example, the lidar device may be configured to select burst mode when higher point cloud resolution is desired for an ROI (e.g., an unidentified object) but standard or normal resolution is desired for other regions within the FOV (e.g., outside the ROI) and/or it is preferred to maintain a current size and/or position for the FOV. Increasing resolution only for the ROI, rather than for the entire FOV, can save energy and/or reduce processing requirements. Further, given time of flight restrictions, burst mode may be appropriate only when the ROI includes near-field objects, for example, to ensure an optical signal reflection is received for a transmitter before the transmitter emits a subsequent optical signal. Additionally or alternatively, the lidar device may be configured to select zoom mode when higher resolution is desired for an ROI and it is acceptable to reduce a current size for the FOV. Zoom mode can be preferable in instances where a wide and/or tall FOV is not needed (e.g., on a highway or when viewing a shelf location in a warehouse). Additionally or alternatively, the lidar device may be configured to select FOV shift mode when it is desirable to maintain a current FOV size and/or point cloud resolution but (i) a significant portion of the FOV encompasses regions that are not of interest (e.g., the sky) and/or (ii) significant regions of interest likely fall outside the FOV. In such instances, FOV shift mode can be selected and used to move the FOV away from regions of lower interest and toward regions of higher interest. In various implementations, the selection criteria for selecting burst mode, zoom mode, and/or FOV shift mode can include: a preferred point cloud resolution for the ROI, a preferred point cloud resolution for regions outside the ROI, a distance between the lidar device and the object, a preferred FOV size, a preferred FOV height, a preferred FOV width, a preferred FOV position, a determination that at least a portion of the ROI falls outside the FOV, a determination that the FOV encompasses regions that are not of interest, or any combination thereof.

In certain examples, a particular lidar device may be capable of performing only a subset of burst mode, zoom mode, and/or FOV shift mode. In such instances, the lidar device may select a mode it is capable of performing and may not select a mode it is incapable of performing. For example, if the lidar device is capable of performing zoom mode but is not capable of performing burst mode or FOV shift mode, the lidar device may be configured to select only zoom mode.

### Some Examples of Continuous Wave (CW) Lidar Systems

As discussed above, some lidar systems may use a continuous wave (CW) laser to detect the range and/or velocity of targets, rather than pulsed TOF techniques. Such systems include continuous wave (CW) coherent lidar systems and frequency modulated continuous wave (FMCW) coherent lidar systems. For example, any of the lidar systems 100, 202, 250, 270, and 304 described above can be configured to operate as a CW coherent lidar system or an FMCW coherent lidar system.

Lidar systems configured to operate as CW or FMCW systems can avoid the eye safety hazards commonly associated with pulsed lidar systems (e.g., hazards that arise from transmitting optical signals with high peak power). In addition, coherent detection may be more sensitive than direct detection and can offer better performance, including single-pulse velocity measurement and immunity to interference from solar glare and other light sources, including other lidar systems and devices.

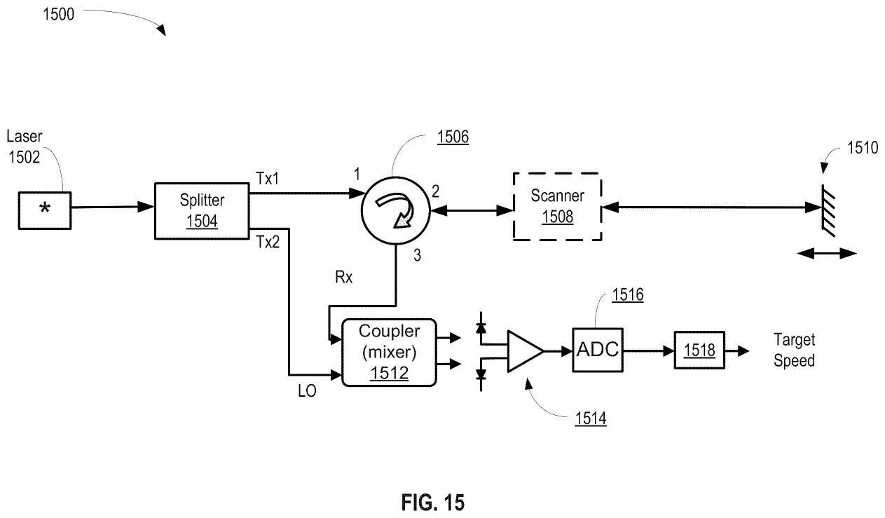

FIG. 15 illustrates an exemplary CW coherent lidar system 1500 configured to determine the radial velocity (or speed) of a target. Lidar system 1500 includes a laser 1502 configured to produce a laser signal which is provided to a splitter 1504. The laser 1502 may provide a laser signal having a substantially constant laser frequency.

In one example, the splitter 1504 provides a first split laser signal Tx1 to a direction selective device 1506, which provides (e.g., forwards) the signal Tx1 to a scanner 1508. In some examples, the direction selective device 1506 is a circulator. The scanner 1508 uses the first laser signal Tx1 to transmit light emitted by the laser 1502 and receives light reflected by the target 1510 (e.g., “reflected light” or “reflections”). The reflected light signal Rx is provided (e.g., passed back) to the direction selective device 1506. The second laser signal Tx2 (provided by the splitter 1504) and the reflected light signal Rx are provided to a coupler (also referred to as a mixer) 1512. The mixer may use the second laser signal Tx2 as a local oscillator (LO) signal and mix it with the reflected light signal Rx. The mixer 1512 may be configured to mix the reflected light signal Rx with the local oscillator signal LO. The mixer 1512 may provide the mixed optical signal to differential photodetector 1514, which may generate an electrical signal representing the beat frequency f_{beat} of the mixed optical signals, where f_{beat}=|f_{Tx2}−f_{Rx}|(the absolute value of the difference between the frequencies of the mixed optical signals). In some embodiments, the current produced by the differential photodetector 614 based on the mixed light may have the same frequency as the beat frequency f_{beat}. The current may be converted to voltage by an amplifier (e.g., a transimpedance amplifier (TIA)), which may be provided (e.g., fed) to an analog-to-digital converter (ADC) 1516 configured to convert the analog voltage signal to digital samples for a target detection module 1518. The target detection module 1518 may be configured to determine (e.g., calculate) the radial velocity of the target 1510 based on the digital sampled signal with beat frequency f_{beat}.

In one example, the target detection module 1518 may identify Doppler frequency shifts using the beat frequency f_{beat} and determine the radial velocity of the target 1510 based on those shifts. For example, the radial velocity of the target 1510 can be calculated using the following relationship:

$${f}_{d} = \frac{2}{λ} {v}_{t}$$

where, f_{d} is the Doppler frequency shift, λ is the wavelength of the laser signal, and vₜ is the radial velocity of the target 1510. In some examples, the direction of the target 1510 is indicated by the sign of the Doppler frequency shift f_{d}. For example, a positive signed Doppler frequency shift may indicate that the target 1510 is traveling towards the system 1500 and a negative signed Doppler frequency shift may indicate that the target 1510 is traveling away from the system 1500.

In one example, a Fourier Transform calculation is performed using the digital samples from the ADC 1516 to recover the desired frequency content (e.g., the Doppler frequency shift) from the digital sampled signal. For example, a controller (e.g., target detection module 1518) may be configured to perform a Discrete Fourier Transform (DFT) on the digital samples. In certain examples, a Fast Fourier Transform (FFT) can be used to calculate the DFT on the digital samples. In some examples, the Fourier Transform calculation (e.g., DFT) can be performed iteratively on different groups of digital samples to generate a target point cloud.

While the lidar system 1500 is described above as being configured to determine the radial velocity of a target, it should be appreciated that the system can be configured to determine the range and/or radial velocity of a target. For example, the lidar system 1500 can be modified to use laser chirps to detect the velocity and/or range of a target.

Some examples have been described in which a DFT is used to generate points of a point cloud based on a group of samples. However, frequency analysis techniques (e.g., spectrum analysis techniques) other than the DFT may be used to generate points of a point cloud based on a group of samples. Any suitable frequency analysis technique may be used, including, without limitation, Discrete Cosine transform (DCT), Wavelet transform, Auto-Regressive moving average (ARMA), etc.

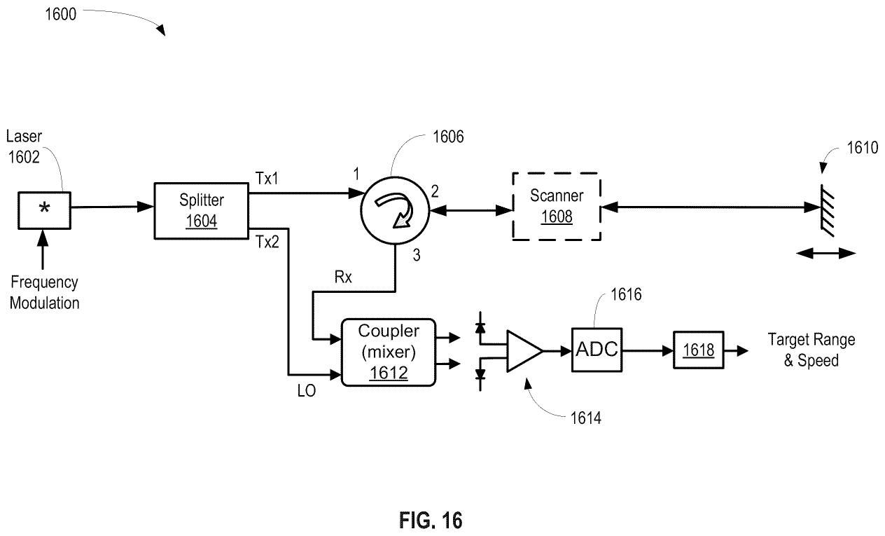

FIG. 16 illustrates an exemplary FMCW coherent lidar system 1600 configured to determine the range and/or radial velocity of a target. Lidar system 1600 includes a laser 1602 configured to produce a laser signal which is fed into a splitter 1604. The laser is “chirped” (e.g., the center frequency of the emitted laser beam is increased (“ramped up” or “chirped up”) or decreased (“ramped down” or “chirped down”) over time (or, equivalently, the central wavelength of the emitted laser beam changes with time within a waveband). In various embodiments, the laser frequency is chirped quickly such that multiple phase angles are attained. In one example, the frequency of the laser signal is modulated by changing the laser operating parameters (e.g., current/voltage) or using a modulator included in the laser source 1602; however, in other examples, an external modulator can be placed between the laser source 1602 and the splitter 1604.

In other examples, the laser frequency can be “chirped” by modulating the phase of the laser signal (or light) produced by the laser 1602. In one example, the phase of the laser signal is modulated using an external modulator placed between the laser source 1602 and the splitter 1604; however, in some examples, the laser source 1602 may be modulated directly by changing operating parameters (e.g., current/voltage) or by including an internal modulator. Similar to frequency chirping, the phase of the laser signal can be increased (“ramped up”) or decreased (“ramped down”) over time.

Some examples of systems with FMCW-based lidar sensors have been described. However, some embodiments of the techniques described herein may be implemented using any suitable type of lidar sensors including, without limitation, any suitable type of coherent lidar sensors (e.g., phase-modulated coherent lidar sensors). With phase-modulated coherent lidar sensors, rather than chirping the frequency of the light produced by the laser (as described above with reference to FMCW techniques), the lidar system may use a phase modulator placed between the laser 1602 and the splitter 1604 to generate a discrete phase modulated signal, which may be used to measure range and radial velocity.

As shown, the splitter 1604 provides a first split laser signal Tx1 to a direction selective device 1606, which provides (e.g., forwards) the signal Tx1 to a scanner 1608. The scanner 1608 uses the first laser signal Tx1 to transmit light emitted by the laser 1602 and receives light reflected by the target 1610. The reflected light signal Rx is provided (e.g., passed back) to the direction selective device 1606. The second laser signal Tx2 and reflected light signal Rx are provided to a coupler (also referred to as a mixer) 1612. The mixer may use the second laser signal Tx2 as a local oscillator (LO) signal and mix it with the reflected light signal Rx. The mixer 1612 may be configured to mix the reflected light signal Rx with the local oscillator signal LO to generate a beat frequency f_{beat}. The mixed signal with beat frequency f_{beat} may be provided to a differential photodetector 1614 configured to produce a current based on the received light. The current may be converted to voltage by an amplifier (e.g., a transimpedance amplifier (TIA)), which may be provided (e.g., fed) to an analog-to-digital converter (ADC) 1616 configured to convert the analog voltage to digital samples for a target detection module 1618. The target detection module 1618 may be configured to determine (e.g., calculate) the range and/or radial velocity of the target 1610 based on the digital sample signal with beat frequency f_{beat}.

Laser chirping may be beneficial for range (distance) measurements of the target. In comparison, Doppler frequency measurements are generally used to measure target velocity. Resolution of distance can depend on the bandwidth size of the chirp frequency band such that greater bandwidth corresponds to finer resolution, according to the following relationships:

$$Range resolution : Δ R = \frac{c}{2 BW} ( given a perfectly linear chirp ) , and \\ Range : R = \frac{{f}_{beat} {cT}_{ChirpRamp}}{2 BW}$$

where c is the speed of light, BW is the bandwidth of the chirped laser signal, f_{beat} is the beat frequency, and T_{ChirpRamp} is the time period during which the frequency of the chirped laser ramps up (e.g., the time period corresponding to the up-ramp portion of the chirped laser). For example, for a distance resolution of 3.0 cm, a frequency bandwidth of 5.0 GHz may be used. A linear chirp can be an effective way to measure range and range accuracy can depend on the chirp linearity. In some instances, when chirping is used to measure target range, there may be range and velocity ambiguity. In particular, the reflected signal for measuring velocity (e.g., via Doppler) may affect the measurement of range. Therefore, some exemplary FMCW coherent lidar systems may rely on two measurements having different slopes (e.g., negative and positive slopes) to remove this ambiguity. The two measurements having different slopes may also be used to determine range and velocity measurements simultaneously.

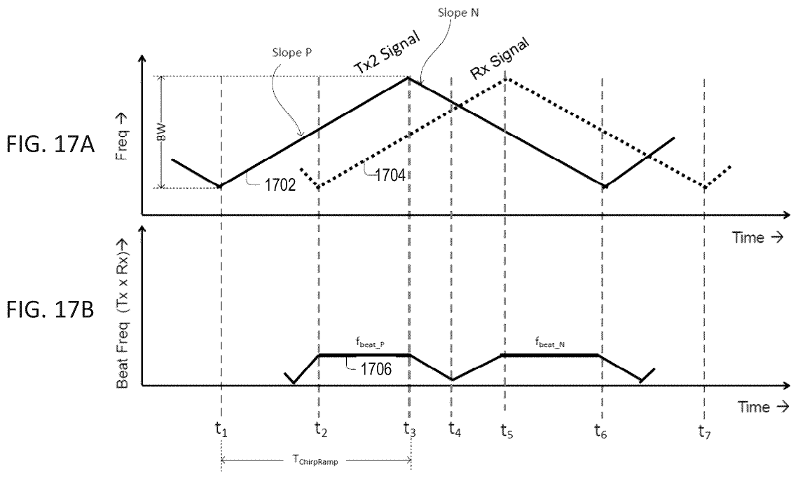

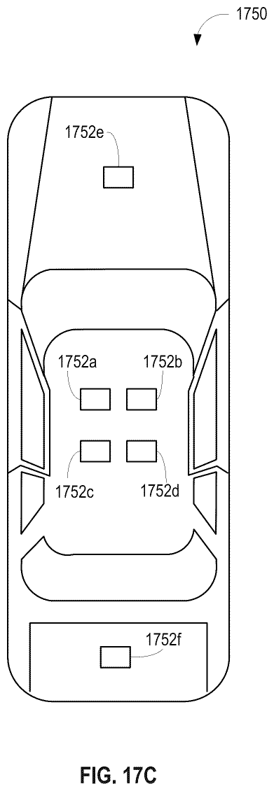

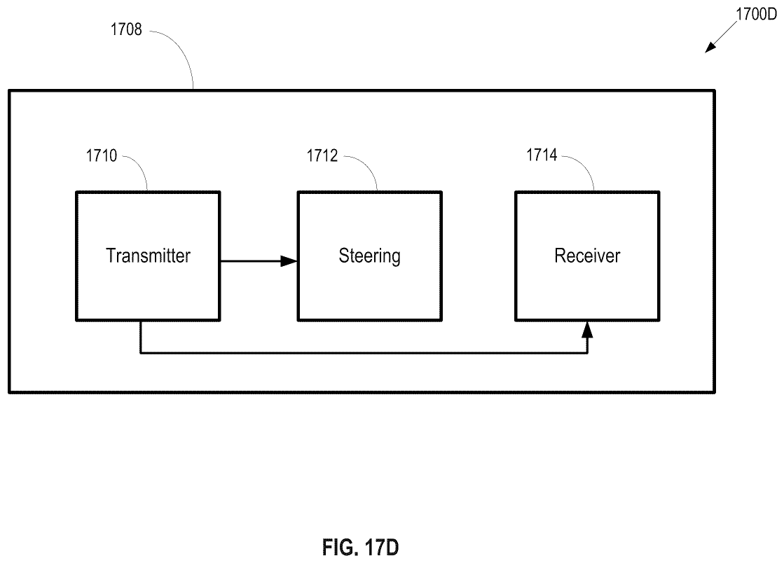

FIG. 17A is a plot of ideal (or desired) frequency chirp as a function of time in the transmitted laser signal Tx (e.g., signal Tx2), depicted in solid line 1702, and reflected light signal Rx, depicted in dotted line 1704. As depicted, the ideal Tx signal has a positive linear slope between time t1 and time t3 and a negative linear slope between time t3 and time t6. Accordingly, the ideal reflected light signal Rx returned with a time delay td of approximately t2−t1 has a positive linear slope between time t2 and time t5 and a negative linear slope between time t5 and time t7.

FIG. 17B is a plot illustrating the corresponding ideal beat frequency f_{beat} 1706 of the mixed signal Tx2×Rx. Note that the beat frequency f_{beat} 1706 has a constant value between time t2 and time t3 (corresponding to the overlapping up-slopes of signals Tx2 and Rx) and between time t5 and time t6 (corresponding to the overlapping down-slopes of signals Tx2 and Rx).

The positive slope (“Slope P”) and the negative slope (“Slope N”) (also referred to as positive ramp (or up-ramp) and negative ramp (or down-ramp), respectively) can be used to determine range and/or velocity. In some instances, referring to FIGS. 17A-17B, when the positive and negative ramp pair is used to measure range and velocity simultaneously, the following relationships are utilized:

$$Range : R = \frac{{cT}_{ChirpRamp} \frac{( {f}_{beat \_ P} + {f}_{beat \_ N} )}{2}}{2 BW} , and \\ Velocity : V = \frac{λ \frac{( {f}_{beat \_ P} - {f}_{beat \_ N} )}{2}}{2}$$

where f_{beat_P} and f_{beat_N} are beat frequencies generated during positive (P) and negative (N) slopes of the chirp 1702 respectively and λ is the wavelength of the laser signal.

In one example, the scanner 1608 of the lidar system 1600 is used to scan the environment and generate a target point cloud from the acquired scan data. In some examples, the lidar system 1600 can use processing methods that include performing one or more Fourier Transform calculations, such as a Fast Fourier Transform (FFT) or a Discrete Fourier Transform (DFT), to generate the target point cloud from the acquired scan data. Being that the system 1600 is capable of measuring range, each point in the point cloud may have a three-dimensional location (e.g., x, y, and z) in addition to radial velocity. In some examples, the x-y location of each target point corresponds to a radial position of the target point relative to the scanner 1608. Likewise, the z location of each target point corresponds to the distance between the target point and the scanner 1608 (e.g., the range). In one example, each target point corresponds to one frequency chirp 1702 in the laser signal. For example, the samples collected by the system 1600 during the chirp 1702 (e.g., t1 to t6) can be processed to generate one point in the point cloud.

### Additional Embodiments, Computing Devices, and Information Handling Systems

In some embodiments, lidar systems and techniques described herein may be used to provide mapping and/or autonomous navigation for a vehicle. FIG. 17C illustrates a vehicle 1750 having a plurality of sensors 1752. As shown, a first sensor 1752a, a second sensor 1752b, a third sensor 1752c, and a fourth sensor 1752d may be positioned in a first location on (or inside) the vehicle 1750 (e.g., the roof). Likewise, a fifth sensor 1752e may be positioned in a second location on (or inside) the vehicle 1750 (e.g., the front of the vehicle 1750) and a sixth sensor 1752f may be positioned in a third location on (or inside) the vehicle 1750 (e.g., the back of the vehicle 1750). In other examples, a different number or configuration of sensors may be used.

In some examples, at least one sensor of the plurality of sensors 1752 is configured to provide (or enable) 3D mapping of the vehicle's surroundings. In certain examples, at least one sensor of the plurality of sensors 1752 is used to provide autonomous navigation for the vehicle 1750 within an environment. In one example, each sensor 1752 includes at least one lidar system, device, or chip. The lidar system(s) included in each sensor 1752 may include any of the lidar systems disclosed herein. In some examples, at least one sensor of the plurality of sensors 1752 may be a different type of sensor (e.g., camera, radar, etc.). In one example, the vehicle 1750 is a car; however, in other examples, the vehicle 1750 may be a truck, boat, plane, drone, vacuum cleaner (e.g., robot vacuum cleaner), robot, train, tractor, ATV, or any other type of vehicle or moveable object.

In some embodiments, lidar systems and techniques described herein may be implemented using Silicon photonics (SiP) technologies. SiP is a material platform from which photonic integrated circuits (PICs) can be produced. SiP is compatible with CMOS (electronic) fabrication techniques, which allows PICs to be manufactured using established foundry infrastructure. In PICs, light propagates through a patterned silicon optical medium that lies on top of an insulating material layer (e.g., silicon on insulator (SOI)). In some cases, direct bandgap materials (e.g., indium phosphide (InP)) are used to create light (e.g., laser) sources that are integrated in an SiP chip (or wafer) to drive optical or photonic components within a photonic circuit. SiP technologies are increasingly used in optical datacom, sensing, biomedical, automotive, astronomy, aerospace, augmented reality (AR) applications, virtual reality (VR) applications, artificial intelligence (AI) applications, navigation, image identification, drones, robotics, etc.

FIG. 17D is a block diagram of a silicon photonic integrated circuit (PIC) 1700D in accordance with aspects described herein. In one example, the lidar systems described herein can be implemented as the PIC 1700D. The PIC 1700D includes a transmitter module 1710, a steering module 1712, and a receiver module 1714. As shown, the transmitter module 1710, the steering module 1712, and the receiver module 1714 are integrated on a silicon substrate 1708.

In other examples, the transmitter module 1710, the steering module 1712, or the receiver module 1714 may be included on a separate substrate. In some embodiments, the steering module 1712 is used by the PIC 1700D in connection with transmission (e.g., emission) and reception (e.g., collection) of optical signals. In some examples, the silicon substrate 1708 is an SOI substrate with a silicon layer (e.g., between 200 nm and 10 microns thick) disposed over an oxide layer (e.g., approximately 2 microns thick). In certain examples, the silicon substrate 1708 can include multiple silicon and/or oxide layers.

In one example, the transmitter module 1710 includes at least one laser source. In some examples, the laser source(s) are implemented using a direct bandgap material (e.g., InP) and integrated on the silicon substrate 1708 via hybrid integration. The transmitter module 1710 may also include at least one splitter, a combiner, and/or a direction selective device that are implemented on the silicon substrate 1708 via monolithic or hybrid integration. In some examples, the laser source(s) are external to the PIC 1700D and the laser signal(s) can be provided to the transmission module 1710.

In some embodiments, lidar systems and techniques described herein may be implemented using micro-electromechanical system (MEMS) devices. A MEMS device is a miniature device that has both mechanical and electronic components. The physical dimension of a MEMS device can range from several millimeters to less than one micrometer. Lidar systems may include one or more scanning mirrors implemented as a MEMS mirror (or an array of MEMS mirrors). Each MEMS mirror may be a single-axis MEMS mirror or dual-axis MEMS mirror. The MEMS mirror(s) may be electromagnetic mirrors. A control signal is provided to adjust the position of the mirror to direct light in at least one scan direction (e.g., horizontal and/or vertical). The MEMS mirror(s) can be positioned to steer light transmitted by the lidar system and/or to steer light received by the lidar system. MEMS mirrors are compact and may allow for smaller form-factor lidar systems, faster control speeds, and more precise light steering compared to other mechanical-scanning lidar methods. MEMS mirrors may be used in solid-state (e.g., stationary) lidar systems and rotating lidar systems.

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), network storage device, or any other suitable device and may vary in size, shape, performance, functionality, and price.

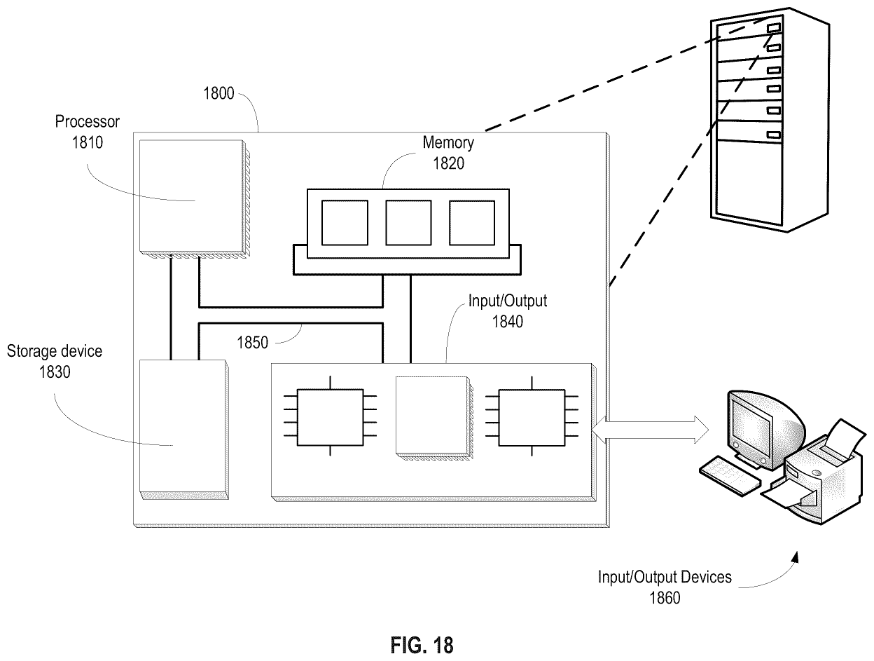

FIG. 18 is a block diagram of an example computer system 1800 that may be used in implementing the technology described in this document. General-purpose computers, network appliances, mobile devices, or other electronic systems may also include at least portions of the system 1800. The system 1800 includes a processor 1810, a memory 1820, a storage device 1830, and an input/output device 1840. Each of the components 1810, 1820, 1830, and 1840 may be interconnected, for example, using a system bus 1850. The processor 1810 is capable of processing instructions for execution within the system 1800. In some implementations, the processor 1810 is a single-threaded processor. In some implementations, the processor 1810 is a multi-threaded processor. In some implementations, the processor 1810 is a programmable (or reprogrammable) general purpose microprocessor or microcontroller. The processor 1810 is capable of processing instructions stored in the memory 1820 or on the storage device 1830.

The memory 1820 stores information within the system 1800. In some implementations, the memory 1820 is a non-transitory computer-readable medium. In some implementations, the memory 1820 is a volatile memory unit. In some implementations, the memory 1820 is a non-volatile memory unit.

The storage device 1830 is capable of providing mass storage for the system 1800. In some implementations, the storage device 1830 is a non-transitory computer-readable medium. In various different implementations, the storage device 1830 may include, for example, a hard disk device, an optical disk device, a solid-date drive, a flash drive, or some other large capacity storage device. For example, the storage device may store long-term data (e.g., database data, file system data, etc.). The input/output device 1840 provides input/output operations for the system 1800. In some implementations, the input/output device 1840 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1860. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1830 may be implemented in a distributed way over a network, for example as a server farm or a set of widely distributed servers, or may be implemented in a single computing device.

Although an example processing system has been described in FIG. 18, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array), an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

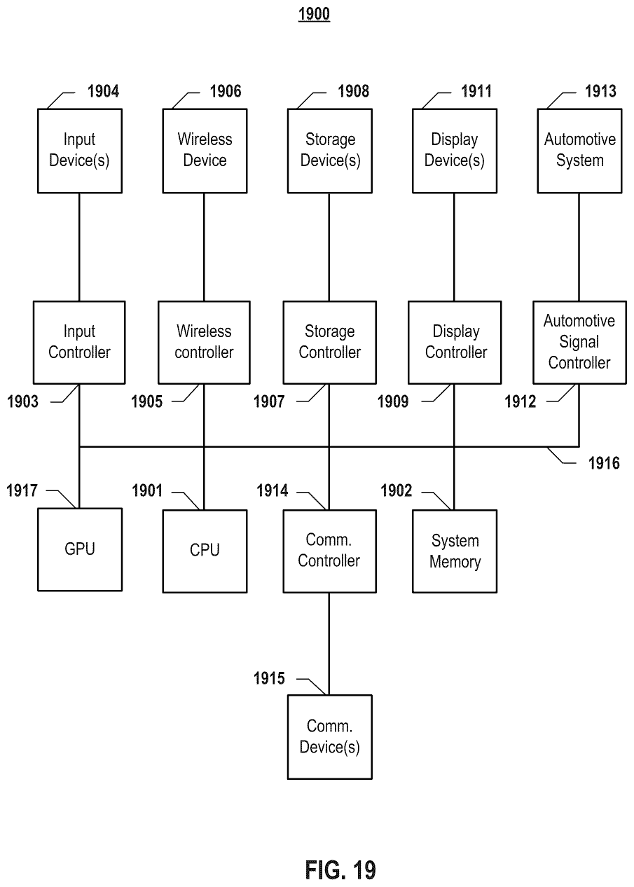

FIG. 19 depicts a simplified block diagram of a computing device/information handling system (or computing system) according to embodiments of the present disclosure. It will be understood that the functionalities shown for system 1900 may operate to support various embodiments of an information handling system—although it shall be understood that an information handling system may be differently configured and include different components.

As illustrated in FIG. 19, system 1900 includes one or more central processing units (CPU) 1901 that provide(s) computing resources and control(s) the computer. CPU 1901 may be implemented with a microprocessor or the like, and may also include one or more graphics processing units (GPU) 1917 and/or a floating point coprocessor for mathematical computations. System 1900 may also include a system memory 1902, which may be in the form of random-access memory (RAM), read-only memory (ROM), or both.

A number of controllers and peripheral devices may also be provided. For example, an input controller 1903 represents an interface to various input device(s) 1904, such as a keyboard, mouse, or stylus. There may also be a wireless controller 1905, which communicates with a wireless device 1906. System 1900 may also include a storage controller 1907 for interfacing with one or more storage devices 1908, each of which includes a storage medium such as a magnetic tape or disk, or an optical medium that might be used to record programs of instructions for operating systems, utilities, and applications, which may include embodiments of programs that implement various aspects of the techniques described herein. Storage device(s) 1908 may also be used to store processed data or data to be processed in accordance with some embodiments. System 1900 may also include a display controller 1909 for providing an interface to a display device 1911, which may be a cathode ray tube (CRT), a thin film transistor (TFT) display, or other type of display. The computing system 1900 may also include an automotive signal controller 1912 for communicating with an automotive system 1913. A communications controller 1914 may interface with one or more communication devices 1915, which enables system 1900 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 1916, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

In embodiments, aspects of the techniques described herein (e.g., timing the emission of optical signals, processing received return signals, generating point clouds, performing one or more (e.g., all) of the steps of the methods described herein, etc.) may be implemented using machine learning and/or artificial intelligence technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. A value of a feature may be a measurement of the corresponding property of an entity or an instance of information regarding an entity. Features can also have data types. For instance, a feature can have an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

As used herein, “data analytics” may refer to the process of analyzing data (e.g., using machine learning models, artificial intelligence, models, or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

Data analytics tools are used to guide decision-making and/or to control systems in a wide variety of fields and industries, e.g., security; transportation; risk assessment and management; supply chain logistics; and energy management. The processes used to develop data analytics tools suitable for carrying out specific data analytics tasks generally include steps of data collection, data preparation, feature engineering, model generation, and/or model deployment.

As used herein, “spatial data” may refer to data relating to the location, shape, and/or geometry of one or more spatial objects. Data collected by lidar systems, devices, and chips described herein may be considered spatial data. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment). In some cases, a spatial object may be represented as a cluster of points in a 3D point-cloud.

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

“Computer vision” generally refers to the use of computer systems to analyze and interpret image data. In some embodiments, computer vision may be used to analyze and interpret data collected by lidar systems (e.g., point-clouds). Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), or high-level (e.g., objects, scenes, events, etc.). The detection/segmentation function may involve selection of a subset of the input image data (e.g., one or more images within a set of images, one or more regions within an image, etc.) for further processing.

### Some Embodiments

Some embodiments may include any of the following:

A1. A method of using lidar, the method comprising: using a lidar device on a vehicle to collect point cloud data for a surrounding environment; determining that enhanced point cloud data should be obtained for a region of interest (ROI) in the environment; and in response to the determination, collecting enhanced point cloud data by at least one of: increasing a density of point cloud measurements within the ROI; or moving a field of view (FOV) for the lidar device according to the ROI.

A2. The method of clause A1, wherein determining that enhanced point cloud data should be obtained comprises: detecting an object in the surrounding environment based on the point cloud data; and determining that the point cloud data is insufficient to characterize or classify the object, and wherein the method further comprises using the enhanced point cloud data to characterize or classify the object.

A3. The method of clause A2, wherein detecting the object comprises detecting a presence of the object without identifying the object.

A4. The method of clause A2 or A3, wherein determining that the point cloud data is insufficient comprises determining that the object is unidentified.

A5. The method of any of clauses A2 to A4, wherein determining that the point cloud data is insufficient comprises determining that the point cloud data is insufficient to determine at least one of a boundary of the object, a velocity of the object, or an orientation of the object.

A6. The method of any of clauses A2 to A5, wherein determining that the point cloud data is insufficient comprises determining that the object is unable to be classified to a threshold level of confidence.

A7. The method of any of clauses A1 to A6, wherein the method comprises increasing the density of point cloud measurements within the ROI, and wherein increasing the density of point cloud measurements comprises increasing a rate at which a transmitter in the lidar device emits optical signals toward the ROI.

A8. The method of any of clauses A1 to A7, wherein the increased rate is limited to the ROI.

A9. The method of any of clauses A1 to A8, wherein the FOV comprises a width and a height, and wherein the increased rate is limited to a portion of the width and a portion of the height.

A10. The method of any of clauses A1 to A9, wherein the method comprises moving the field of view (FOV) for the lidar device according to the ROI.

A11. The method of any of clauses A1 to A10, wherein moving the FOV comprises translating a center of the FOV toward the ROI.

A12. The method of any of clauses A1 to A11, wherein moving the FOV comprises translating the FOV up or down.

A13. The method of any of clauses A1 to A12, wherein collecting enhanced point cloud data for the object comprises selecting an operating mode for the lidar device based on at least one of: a preferred point cloud resolution for the ROI, a preferred point cloud resolution for regions outside the ROI, a distance between the lidar device and the object, a preferred FOV size, a preferred FOV height, a preferred FOV width, a preferred FOV position, a determination that at least a portion of the ROI falls outside the FOV, a determination that the FOV encompasses regions that are not of interest, or any combination thereof.

A14. The method of any of clauses A1 to A13, wherein the method comprises increasing the density of point cloud measurements within the ROI, and wherein increasing the density of point cloud measurements comprises decreasing the FOV for the lidar device.

A15. The method of any of clauses A1 to A14, wherein the determination that enhanced point cloud data should be obtained is based on at least one of a velocity or a location for the vehicle.

A16. The method of any of clauses A14 or A15, wherein determining that enhanced point cloud data should be obtained comprises determining the velocity based on a signal from a speedometer or a vehicle control system for the vehicle.

A17. The method of any of clauses A14 to A16, wherein determining that enhanced point cloud data should be obtained comprises determining that the velocity has increased.

A18. The method of any of clauses A14 to A17, wherein determining that enhanced point cloud data should be obtained comprises determining that the velocity is greater than a threshold value.

A19. The method of any of clauses A14 to A18, wherein determining that enhanced point cloud data should be obtained comprises determining the location using a global positioning system.

A20. The method of any of clauses A14 to A19, wherein determining that enhanced point cloud data should be obtained comprises determining that the location has moved from a slow-speed environment to a high-speed environment.

A21. The method of any of clauses A14 to A20, wherein determining that enhanced point cloud data should be obtained comprises determining that the location is on a highway.

A22. The method of any of clauses A14 to A21, wherein decreasing the FOV comprises decreasing at least one of an azimuth angle or an elevation angle.

A23. The method of any of clauses A14 to A22, wherein decreasing the FOV comprises decreasing a spacing between data points in the point cloud.

A24. The method of any of clauses A14 to A24, wherein decreasing the FOV comprises maintaining a rate at which optical signals are sent from the lidar device into the surrounding environment.

A25. A system comprising: a lidar device mounted on a vehicle and configured to collect point cloud data for a surrounding environment; and at least one computer processor programmed to perform operations comprising: determining that enhanced point cloud data should be obtained for a region of interest (ROI) in the environment; and in response to the determination, instructing the lidar device to collect the enhanced point cloud data by at least one of: increasing a density of point cloud measurements within the ROI; or moving a field of view (FOV) for the lidar device according to the ROI.

A26. The system of clause A25, wherein the at least one computer processor instructs the lidar device to collect the enhanced point cloud data by increasing a density of point cloud measurements within the ROI, and wherein increasing the density of point cloud measurements comprises increasing a rate at which a transmitter in the lidar device emits optical signals toward the ROI.

A27. The system of clauses A25 or A26, wherein the at least one computer processor instructs the lidar device to collect the enhanced point cloud data by moving the FOV for the lidar device according to the ROI.

A28. The system of any of clauses A25 to A27, wherein the at least one computer processor instructs the lidar device to collect the enhanced point cloud data by increasing the density of point cloud measurements within the ROI, and wherein increasing the density of point cloud measurements comprises decreasing the FOV for the lidar device.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of using lidar, the method comprising:
using a lidar device on a vehicle to collect point cloud data for a surrounding environment;
determining that enhanced point cloud data should be obtained for a region of interest (ROI) in the environment; and
in response to the determination, collecting enhanced point cloud data by at least one of:
increasing a density of point cloud measurements within the ROI; or
moving a field of view (FOV) for the lidar device according to the ROI.

2. The method of claim 1, wherein determining that enhanced point cloud data should be obtained comprises:
detecting an object in the surrounding environment based on the point cloud data; and
determining that the point cloud data is insufficient to characterize or classify the object, and wherein the method further comprises using the enhanced point cloud data to characterize or classify the object.

3. The method of claim 2, wherein detecting the object comprises detecting a presence of the object without identifying the object.

4. The method of claim 2, wherein determining that the point cloud data is insufficient comprises determining that the object is unidentified.

5. The method of claim 2, wherein determining that the point cloud data is insufficient comprises determining that the point cloud data is insufficient to determine at least one of a boundary of the object, a velocity of the object, or an orientation of the object.

6. The method of claim 2, wherein determining that the point cloud data is insufficient comprises determining that the object is unable to be classified to a threshold level of confidence.

7. The method of claim 1, wherein the method comprises increasing the density of point cloud measurements within the ROI, and wherein increasing the density of point cloud measurements comprises increasing a rate at which a transmitter in the lidar device emits optical signals toward the ROI.

8. The method of claim 7, wherein the increased rate is limited to the ROI.

9. The method of claim 7, wherein the FOV comprises a width and a height, and wherein the increased rate is limited to a portion of the width and a portion of the height.

10. The method of claim 1, wherein the method comprises moving the field of view (FOV) for the lidar device according to the ROI.

11. The method of claim 10, wherein moving the FOV comprises translating a center of the FOV toward the ROI.

12. The method of claim 10, wherein moving the FOV comprises translating the FOV up or down.

13. The method of claim 1, wherein collecting enhanced point cloud data for the object comprises selecting an operating mode for the lidar device based on at least one of: a preferred point cloud resolution for the ROI, a preferred point cloud resolution for regions outside the ROI, a distance between the lidar device and the object, a preferred FOV size, a preferred FOV height, a preferred FOV width, a preferred FOV position, a determination that at least a portion of the ROI falls outside the FOV, a determination that the FOV encompasses regions that are not of interest, or any combination thereof.

14. The method of claim 1, wherein the method comprises increasing the density of point cloud measurements within the ROI, and wherein increasing the density of point cloud measurements comprises decreasing the FOV for the lidar device.

15. The method of claim 14, wherein the determination that enhanced point cloud data should be obtained is based on at least one of a velocity or a location for the vehicle.

16. The method of claim 15, wherein determining that enhanced point cloud data should be obtained comprises determining the velocity based on a signal from a speedometer or a vehicle control system for the vehicle.

17. The method of claim 15, wherein determining that enhanced point cloud data should be obtained comprises determining that the velocity has increased.

18. The method of claim 15, wherein determining that enhanced point cloud data should be obtained comprises determining that the velocity is greater than a threshold value.

19. The method of claim 15, wherein determining that enhanced point cloud data should be obtained comprises determining the location using a global positioning system.

20. The method of claim 15, wherein determining that enhanced point cloud data should be obtained comprises determining that the location has moved from a slow-speed environment to a high-speed environment.

21. The method of claim 15, wherein determining that enhanced point cloud data should be obtained comprises determining that the location is on a highway.

22. The method of claim 14, wherein decreasing the FOV comprises decreasing at least one of an azimuth angle or an elevation angle.

23. The method of claim 14, wherein decreasing the FOV comprises decreasing a spacing between data points in the point cloud.

24. The method of claim 14, wherein decreasing the FOV comprises maintaining a rate at which optical signals are sent from the lidar device into the surrounding environment.

25. A system comprising:
a lidar device mounted on a vehicle and configured to collect point cloud data for a surrounding environment; and
at least one computer processor programmed to perform operations comprising:
determining that enhanced point cloud data should be obtained for a region of interest (ROI) in the environment; and
in response to the determination, instructing the lidar device to collect the enhanced point cloud data by at least one of:
increasing a density of point cloud measurements within the ROI; or
moving a field of view (FOV) for the lidar device according to the ROI.

26. The system of claim 25, wherein the at least one computer processor instructs the lidar device to collect the enhanced point cloud data by increasing a density of point cloud measurements within the ROI, and wherein increasing the density of point cloud measurements comprises increasing a rate at which a transmitter in the lidar device emits optical signals toward the ROI.

27. The system of claim 25, wherein the at least one computer processor instructs the lidar device to collect the enhanced point cloud data by moving the FOV for the lidar device according to the ROI.

28. The system of claim 25, wherein the at least one computer processor instructs the lidar device to collect the enhanced point cloud data by increasing the density of point cloud measurements within the ROI, and wherein increasing the density of point cloud measurements comprises decreasing the FOV for the lidar device.
